(19) United States
(12) Patent Application Publication
(10) Pub. No.: US 2025/0137927 A1
(43) Pub. Date: May 1, 2025

(54) IMAGE-SENSOR-BASED SCATTERING MEASUREMENT SYSTEM AND METHOD

(71) Applicant: Meta Platforms Technologies, LLC, Menlo Park, CA (US)

(72) Inventor: Jian XU, Redmond, WA (US)

(21) Appl. No.: 17/979,226

(22) Filed: Nov. 2, 2022

Related U.S. Application Data
(60) Provisional application No. 63/320,568, filed on Mar. 16, 2022.

(51) Int. Cl. G01N 21/47

(52) U.S. Cl. CPC G01N 21/4738; G01N 2021/4704; G01N 2201/06113

(57) ABSTRACT

A system is provided. The system includes a light source configured to emit a probing beam to illuminate an optical element. The system also includes an image sensor configured to be rotatable around the optical element within a predetermined rotation range. The system also includes a controller configured to control the image senor to move to a plurality of angular sub-ranges of the predetermined rotation range to receive a plurality of scattered beams output from the optical element. The image sensor is configured to generate a plurality of sets of speckle pattern image data based on the received scattered beams. The sets of speckle pattern image data provide two-dimensional (“2D”) spatial information of speckles.

### CROSS REFERENCE TO RELATED APPLICATION

This application claims the benefit of priority to U.S. Provisional Application No. 63/320,568, filed on Mar. 16, 2022. The content of the above-mentioned application is incorporated herein by reference in its entirety.

### TECHNICAL FIELD

The present disclosure generally relates to optical systems and methods and, more specifically, to an image-sensor-based scattering measurement system and a method thereof.

### BACKGROUND

Scattering quantification is a routine and essential step in the field of optics and photonics, ranging from conventional lenses and glasses to photonics chips and waveguides. However, it is a challenging task for a conventional scattering measurement system in multiple perspectives. For example, a conventional system may detect the light scattering of an optical component by using a probing beam and a photodetector (e.g., a single photodiode functioning as a single pixel). The energy of the scattered beams may be multiple orders of magnitude weaker than the probing beam, requiring the photodiode to have a large dynamic detection range. The scattered beams may spread over the entire 4 π steradian angularly, requiring the photodiode to have a high sensitivity. In addition, due to the weak scattering nature of typical optical components, a stray light (e.g., an ambient light) may overwhelm the scattered beams if the conventional system is not carefully designed and calibrated. As the stray light can be as weak as the scattered light, the troubleshooting of the stray light in the conventional system may be difficult.

### SUMMARY OF THE DISCLOSURE

Consistent with an aspect of the present disclosure, a system is provided. The system includes a light source configured to emit a probing beam to illuminate an optical element. The system also includes an image sensor configured to be rotatable around the optical element within a predetermined rotation range. The system also includes a controller configured to control the image senor to move to a plurality of angular sub-ranges of the predetermined rotation range to receive a plurality of scattered beams output from the optical element. The image sensor is configured to generate a plurality of sets of speckle pattern image data based on the received scattered beams. The sets of speckle pattern image data provide two-dimensional (“2D”) spatial information of speckles.

Consistent with another aspect of the present disclosure, a method is provided. The method includes determining a plurality of exposure times of an image sensor for a plurality of angular sub-ranges of a predetermined rotation range around an optical element. The method also includes, with a light source turned on, moving the imaging sensor around the optical element to the plurality of angular sub-ranges to generate a plurality of sets of speckle pattern image data based on a plurality of scattered beams output from the optical element, using the respective pre-set exposure times at the respective angular sub-ranges. The method also includes, with the light source turned off, moving the imaging sensor around the optical element to the plurality of angular sub-ranges to generate a plurality of sets of dark frame image data, using the respective pre-set exposure times at the respective angular sub-ranges. The method also includes processing the plurality of sets of speckle pattern image data and the plurality of sets of dark frame image data to obtain an angular-dependent scattering intensity profile of the optical element.

Other aspects of the present disclosure can be understood by those skilled in the art in light of the description, the claims, and the drawings of the present disclosure. The foregoing general description and the following detailed description are exemplary and explanatory only and are not restrictive of the claims.

### BRIEF DESCRIPTION OF THE DRAWINGS

The following drawings are provided for illustrative purposes according to various disclosed embodiments and are not intended to limit the scope of the present disclosure. In the drawings:

FIG. 1 illustrates a schematic diagram of a conventional scattering measurement system using a lock-in detection technology;

FIG. 2A illustrates a schematic diagram of a near-eye display (“NED”), according to an embodiment of the present disclosure;

FIG. 2B illustrates a schematic cross sectional view of half of the NED shown in FIG. 2A, according to an embodiment of the present disclosure;

FIG. 3 illustrates a schematic diagram of a light guide display system, according to an embodiment of the present disclosure;

FIG. 4A illustrates a schematic diagram of a scattering measurement system, according to an embodiment of the present disclosure;

FIG. 4B illustrates divisions of a predetermined rotation range into a plurality of angular sub-ranges in the system shown in FIG. 4A, according to an embodiment of the present disclosure;

FIG. 4C illustrates a plot showing a relationship between the measured scattering intensity and the scattering angle, according to an embodiment of the present disclosure;

FIGS. 4D and 4E illustrate a troubleshooting of a stray light in the system shown in FIG. 4A, according to an embodiment of the present disclosure;

FIG. 4F is a sample image acquired by the system shown in FIG. 4A showing effect of a stray light, according to an embodiment of the present disclosure;

FIG. 4G is a sample image acquired by the system shown in FIG. 4A after the troubleshooting processes shown in FIGS. 4D and 4E are performed, according to an embodiment of the present disclosure;

FIG. 4H illustrates a schematic diagram of a scattering measurement system, according to an embodiment of the present disclosure;

FIG. 5 is a flowchart illustrating a method for scattering measurement of an optical component or element, according to an embodiment of the present disclosure;

FIG. 6A schematically illustrates a three-dimensional (“3D”) view of an optical film that may be included in an optical component, the optical property of which may be measured by the system shown in FIGS. 4A-4H, according to an embodiment of the present disclosure;

FIGS. 6B-6D schematically illustrate various views of a portion of the optical film shown in FIG. 6A, showing in-plane orientations of optically anisotropic molecules in the optical film, according to various embodiments of the present disclosure;

FIGS. 6E-6H schematically illustrate various views of a portion of the optical film shown in FIG. 6A, showing out-of-plane orientations of optically anisotropic molecules in the optical film, according to various embodiments of the present disclosure;

FIGS. 7A-7C schematically illustrate processes for fabricating an optical component with a layered structure, according to an embodiment of the present disclosure; and

FIGS. 8A and 8B schematically illustrate processes for fabricating an optical component with a layered structure, according to an embodiment of the present disclosure.

### DETAILED DESCRIPTION

Embodiments consistent with the present disclosure will be described with reference to the accompanying drawings, which are merely examples for illustrative purposes and are not intended to limit the scope of the present disclosure. Wherever possible, the same reference numbers are used throughout the drawings to refer to the same or similar parts, and a detailed description thereof may be omitted.

Further, in the present disclosure, the disclosed embodiments and the features of the disclosed embodiments may be combined. The described embodiments are some but not all of the embodiments of the present disclosure. Based on the disclosed embodiments, persons of ordinary skill in the art may derive other embodiments consistent with the present disclosure. For example, modifications, adaptations, substitutions, additions, or other variations may be made based on the disclosed embodiments. Such variations of the disclosed embodiments are still within the scope of the present disclosure. Accordingly, the present disclosure is not limited to the disclosed embodiments. Instead, the scope of the present disclosure is defined by the appended claims.

As used herein, the terms “couple,” “coupled,” “coupling,” or the like may encompass an optical coupling, a mechanical coupling, an electrical coupling, an electromagnetic coupling, or any combination thereof. An “optical coupling” between two optical elements refers to a configuration in which the two optical elements are arranged in an optical series, and a light output from one optical element may be directly or indirectly received by the other optical element. An optical series refers to optical positioning of a plurality of optical elements in a light path, such that a light output from one optical element may be transmitted, reflected, diffracted, converted, modified, or otherwise processed or manipulated by one or more of other optical elements. In some embodiments, the sequence in which the plurality of optical elements are arranged may or may not affect an overall output of the plurality of optical elements. A coupling may be a direct coupling or an indirect coupling (e.g., coupling through an intermediate element).

The phrase “at least one of A or B” may encompass all combinations of A and B, such as A only, B only, or A and B. Likewise, the phrase “at least one of A, B, or C” may encompass all combinations of A, B, and C, such as A only, B only, C only, A and B, A and C, B and C, or A and B and C. The phrase “A and/or B” may be interpreted in a manner similar to that of the phrase “at least one of A or B.” For example, the phrase “A and/or B” may encompass all combinations of A and B, such as A only, B only, or A and B. Likewise, the phrase “A, B, and/or C” has a meaning similar to that of the phrase “at least one of A, B, or C.” For example, the phrase “A, B, and/or C” may encompass all combinations of A, B, and C, such as A only, B only, C only, A and B, A and C, B and C, or A and B and C.

When a first element is described as “attached,” “provided,” “formed,” “affixed,” “mounted,” “secured,” “connected,” “bonded,” “recorded,” or “disposed,” to, on, at, or at least partially in a second element, the first element may be “attached,” “provided,” “formed,” “affixed,” “mounted,” “secured,” “connected,” “bonded,” “recorded,” or “disposed,” to, on, at, or at least partially in the second element using any suitable mechanical or non-mechanical manner, such as depositing, coating, etching, bonding, gluing, screwing, press-fitting, snap-fitting, clamping, etc. In addition, the first element may be in direct contact with the second element, or there may be an intermediate element between the first element and the second element. The first element may be disposed at any suitable side of the second element, such as left, right, front, back, top, or bottom.

When the first element is shown or described as being disposed or arranged “on” the second element, term “on” is merely used to indicate an example relative orientation between the first element and the second element. The description may be based on a reference coordinate system shown in a figure, or may be based on a current view or example configuration shown in a figure. For example, when a view shown in a figure is described, the first element may be described as being disposed “on” the second element. It is understood that the term “on” may not necessarily imply that the first element is over the second element in the vertical, gravitational direction. For example, when the assembly of the first element and the second element is turned 180 degrees, the first element may be “under” the second element (or the second element may be “on” the first element). Thus, it is understood that when a figure shows that the first element is “on” the second element, the configuration is merely an illustrative example. The first element may be disposed or arranged at any suitable orientation relative to the second element (e.g., over or above the second element, below or under the second element, left to the second element, right to the second element, behind the second element, in front of the second element, etc.).

When the first element is described as being disposed “on” the second element, the first element may be directly or indirectly disposed on the second element. The first element being directly disposed on the second element indicates that no additional element is disposed between the first element and the second element. The first element being indirectly disposed on the second element indicates that one or more additional elements are disposed between the first element and the second element.

The term “processor” used herein may encompass any suitable processor, such as a central processing unit (“CPU”), a graphics processing unit (“GPU”), an application-specific integrated circuit (“ASIC”), a programmable logic device (“PLD”), or any combination thereof. Other processors not listed above may also be used. A processor may be implemented as software, hardware, firmware, or any combination thereof.

The term “controller” may encompass any suitable electrical circuit, software, or processor configured to generate a control signal for controlling a device, a circuit, an optical element, etc. A “controller” may be implemented as software, hardware, firmware, or any combination thereof. For example, a controller may include a processor, or may be included as a part of a processor.

The term “non-transitory computer-readable medium” may encompass any suitable medium for storing, transferring, communicating, broadcasting, or transmitting data, signal, or information. For example, the non-transitory computer-readable medium may include a memory, a hard disk, a magnetic disk, an optical disk, a tape, etc. The memory may include a read-only memory (“ROM”), a random-access memory (“RAM”), a flash memory, etc. The term “film,” “layer,” “coating,” or “plate” may include rigid or flexible, self-supporting or free-standing film, layer, coating, or plate, which may be disposed on a supporting substrate or between substrates. The terms “film,” “layer,” “coating,” and “plate” may be interchangeable.

The phrases “in-plane direction,” “in-plane orientation,” “in-plane rotation,” “in-plane alignment pattern,” and “in-plane pitch” refer to a direction, an orientation, a rotation, an alignment pattern, and a pitch in a plane of a film or a layer (e.g., a surface plane of the film or layer, or a plane parallel to the surface plane of the film or layer), respectively. The term “out-of-plane direction” or “out-of-plane orientation” indicates a direction or orientation that is non-parallel to the plane of the film or layer (e.g., perpendicular to the surface plane of the film or layer, e.g., perpendicular to a plane parallel to the surface plane). For example, when an “in-plane” direction or orientation refers to a direction or orientation within a surface plane, an “out-of-plane” direction or orientation may refer to a thickness direction or orientation perpendicular to the surface plane, or a direction or orientation that is not parallel with the surface plane.

The term “orthogonal” as used in “orthogonal polarizations” or the term “orthogonally” as used in “orthogonally polarized” means that an inner product of two vectors representing the two polarizations is substantially zero. For example, two lights or beams with orthogonal polarizations (or two orthogonally polarized lights or beams) may be two linearly polarized lights (or beams) with two orthogonal polarization directions (e.g., an x-axis direction and a y-axis direction in a Cartesian coordinate system) or two circularly polarized lights with opposite handednesses (e.g., a left-handed circularly polarized light and a right-handed circularly polarized light).

The wavelength ranges, spectra, or bands mentioned in the present disclosure are for illustrative purposes. The disclosed optical device, system, element, assembly, and method may be applied to a visible wavelength band, as well as other wavelength bands, such as an ultraviolet (“UV”) wavelength band, an infrared (“IR”) wavelength band, or a combination thereof. The term “substantially” or “primarily” used to modify an optical response action, such as transmit, reflect, diffract, block or the like that describes processing of a light means that a majority portion, including all, of a light is transmitted, reflected, diffracted, or blocked, etc. The majority portion may be a predetermined percentage (greater than 50%) of the entire light, such as 100%, 98%, 90%, 85%, 80%, etc., which may be determined based on specific application needs.

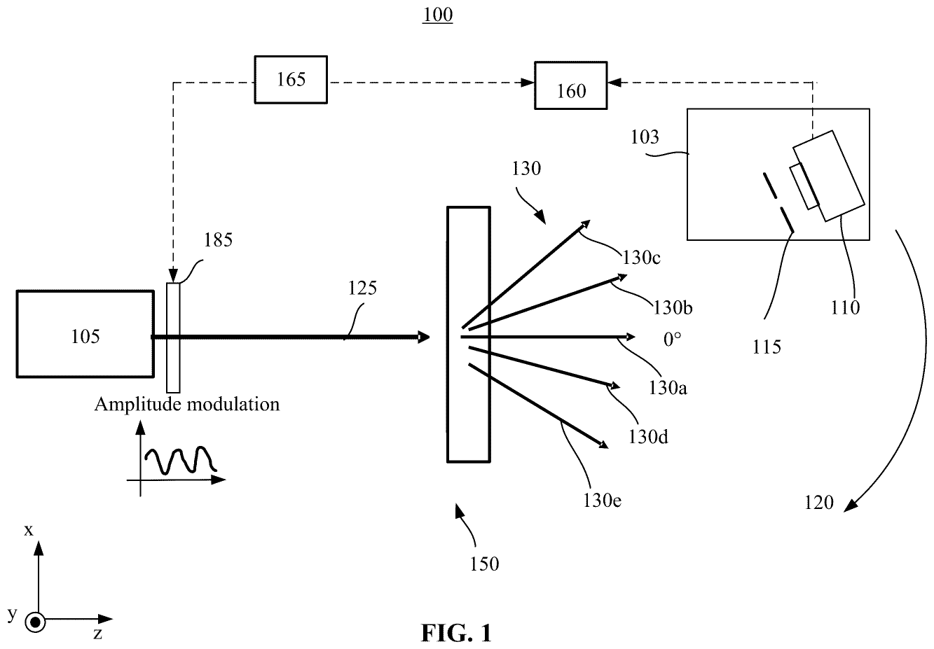

A conventional system and method for measuring an angular dependent optical property (e.g., scattering property) of an optical element (or optical component) typically use an ultrasensitive photodetector with expensive lock-in detection to boost the signal-to-noise ratio and dynamic range. FIG. 1 schematically illustrates a conventional system 100. The system 100 may measure scattering of an optical component using an ultrasensitive photodetector with lock-in detection. As shown in FIG. 1, the system 100 may include a light source (e.g., a laser diode) 105, an optical chopper (or an optical modulator) 185 disposed in front of the light source 105, a lock-in amplifier 160, a detection assembly 103, and a controller 165 communicatively coupled with the lock-in amplifier 160 and the optical chopper 185. A sample (e.g., an optical component or element) 150 may be disposed between the optical chopper 185 and the detection assembly 103. The optical chopper 185 may be disposed between the light source 105 and the sample 150. The light source 105 may also be referred to as an illumination device. The light source 105 may emit a beam (or a light) toward the optical chopper 185 for illuminating the sample 150. The controller 165 may control the optical chopper 185 to apply an amplitude modulation (e.g., a sinusoidal amplitude modulation shown in FIG. 1) at a reference frequency to the beam received from the light source 105. The optical chopper 185 may output a modulated beam 125 toward the sample 150. The controller 165 may also provide a defined reference signal at the reference frequency to the lock-in amplifier 160.

The modulated beam 125 incident onto the sample 150 may be referred to as a probing beam. The probing beam 125 may propagate through the sample 150 as transmitted beams 130, which may include a directly transmitted beam 130a and a plurality of scattered beams 130b-130e. The beams 130a-130e have different scattering angles (for simplicity of discussion and illustration, the “scattering angle” corresponding to the directly transmitted beam 130a is 0°). For simplicity of discussion, the directly transmitted beam is also considered as a scattered beam with a scattering angle of 0°. The detection assembly 103 may include a photodetector 110 and a diaphragm (e.g., an iris) 115 disposed in front of the photodetector 110. The photodetector 110 may include a single photodiode (also referred to as 110) functioning as a single pixel for detecting a beam. The photodiode 110 may be a semiconductor device with a p-n junction or p-i-n structure that converts photons (or light) into an electrical current. The photodiode 110 may be an ultrasensitive photodiode. The detection assembly 103 may be moved along a direction 120 around the sample 150 from one angular position to another angular position, such that the photodetector 110 may detect one of the beams 130a-130e. For example the detection assembly 103 may be mounted on a movable stage or arm, and the controller 165 may control the movement of the movable stage or arm, thereby moving the detection assembly 103 to different angular positions.

The lock-in amplifier 160 may also be communicatively coupled with the photodetector 110, may receive an input signal from the photodetector 110, and may process the received input signal. The optical chopper 185 and the photodetector 110 may be synchronized for the lock-in detection. Based on the lock-in detection technique, the amplitude and/or the phase of an input signal (i.e., one of the beams 130a-130e) relative to the defined reference signal may be measured, even if the input signal is much weaker than the noise (the noise may be a stray light or ambient light). The lock-in detection of the light scattering of the sample 150 may be complicated, expensive, and time consuming. Furthermore, the photodiode 110 may measure scattering light intensities at different angular positions (corresponding to different scattering angles). However, the photodiode 110 functioning as a single pixel for detection may not provide 2D spatial information of the measured scattered light intensity. Thus, it may be difficult to perform troubleshooting of stray lights for the system 100 when the noise (e.g., stray light) is also captured by the photodetector 110.

The present disclosure provides a lock-in-detection free scattering measurement technique based on an image sensor, e.g., a camera sensor. The disclosed system and method for measuring light scattering of an optical component (or optical element) are low-cost, high detection sensitivity, high detection efficiency, and easy for troubleshooting of stray lights. The disclosed system and method may be adopted in quality control process of mass production of optical components, elements, devices, or systems.

In some embodiments, the optical component may include a single layer. In some embodiments, the optical component may include a plurality of layers of films or plates stacked together, referred to as a layered structure. The optical component with the layered structure may include at least two layers of different materials and/or structures. For example, the optical component with the layered structure may include a substate, one or more optical films disposed on the substate, and a protecting film disposed on the optical films. In some embodiments, the optical component with the layered structure may include other elements, such as an alignment structure (or layer) disposed between the substate and the optical film, a cover glass disposed on the protecting film, etc. The optical film may be configured with a predetermined optical function. For example, the optical film may function as a transmissive or reflective optical element, such as a grating, a lens or lens array, a prism, a polarizer, a compensation plate, or a phase retarder, etc.

In some embodiments, the optical element may include a birefringent medium. The optical element may also be referred to as a birefringent medium layer. In some embodiments, an optic axis of the birefringent medium layer may be configured with a spatially varying orientation in at least one in-plane direction of the optical film. In some embodiments, the optical element may include a photo-polymer layer. In some embodiments, the photo-polymer layer may be a liquid crystal polymer (“LCP”) layer that includes polymerized (or cross-linked) liquid crystals (“LCs”), polymer-stabilized LCs, a photo-sensitive LC polymer, or any combination thereof. The LCs may include nematic LCs, twist-bend LCs, chiral nematic LCs, smectic LCs, or any combination thereof. In some embodiments, the photo-polymer layer may include a birefringent photo-refractive holographic material other than LCs, such as an amorphous polymer. In some embodiments, the optical element may function as a Pancharatnam-Berry phase (“PBP”), a polarization volume hologram (“PVH”) element, or a volumetric Bragg grating element. The optical element may be implemented in systems or devices for beam steering, display, imaging, sensing, communication, biomedical applications, etc. In some embodiments, the optical element may include a photosensitive material that provides a refractive index modulation based on an exposure light pattern. In some embodiments, the photo-polymer layer may be configured with a refractive index modulation in the photo-polymer layer. Hence, the photo-polymer layer may be referred to as a photosensitive index modulation polymer.

For example, the optical element may function as a beam steering device, which may be implemented in various systems for augmented reality (“AR”), virtual reality (“VR”), and/or mixed reality (“MR”) applications, e.g., near-eye displays (“NEDs”), head-up displays (“HUDs”), head-mounted displays (“HMDs”), smart phones, laptops, televisions, vehicles, etc. For example, the beam steering devices may be implemented in displays and optical modules to enable pupil steered AR, VR, and/or MR display systems, such as holographic near eye displays, retinal projection eyewear, and wedged waveguide displays. Pupil steered AR, VR, and/or MR display systems have features such as compactness, large field of views (“FOVs”), high system efficiencies, and small eye-boxes. The beam steering device may be implemented in the pupil steered AR, VR, and/or MR display systems to enlarge the eye-box spatially and/or temporally. In some embodiments, the beam steering device may be implemented in AR, VR, and/or MR sensing modules to detect objects in a wide angular range to enable other functions. In some embodiments, the beam steering device may be implemented in AR, VR, and/or MR sensing modules to extend the FOV (or detecting range) of the sensors in space constrained optical systems, increase detecting resolution or accuracy of the sensors, and/or reduce the signal processing time. In some embodiments, the beam steering device may be used in Light Detection and Ranging (“Lidar”) systems in autonomous vehicles. In some embodiments, the beam steering device may be used in optical communications, e.g., to provide fast speeds (e.g., speeds at the level of Gigabyte/second) and long ranges (e.g., ranges at kilometer levels). In some embodiments, the beam steering device may be implemented in microwave communications, 3D imaging and sensing (e.g., Lidar), lithography, and 3D printing, etc.

In some embodiments, the optical element may function as an imaging device, which may be implemented in various systems for AR, VR, and/or MR applications, enabling light-weight and ergonomic designs for AR, VR, and/or MR devices. For example, the imaging device may be implemented in displays and optical modules to enable smart glasses for AR, VR, and/or MR applications, compact illumination optics for projectors, light-field displays. In some embodiments, the imaging device may replace conventional objective lenses having a high numerical aperture in microscopes. In some embodiments, the imaging device may be implemented into light source assemblies to provide a polarized structured illumination to a sample, for identifying various features of the sample. In some embodiments, the imaging device may enable polarization patterned illumination systems that add a new degree for sample analysis.

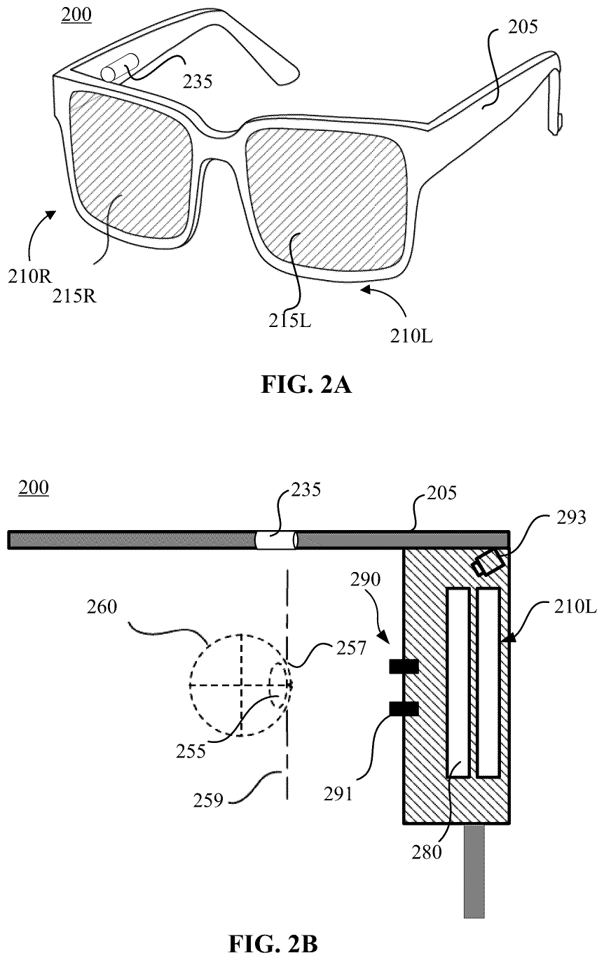

Some exemplary applications in AR, VR, or MR fields or some combinations thereof will be explained below. FIG. 2A illustrates a schematic diagram of a near-eye display (“NED”) 200 according to an embodiment of the disclosure. FIG. 2B is a cross-sectional view of half of the NED 200 shown in FIG. 2A according to an embodiment of the disclosure. For purposes of illustration, FIG. 2B shows the cross-sectional view associated with a left-eye display system 210L. The NED 200 may include a controller (not shown). The NED 200 may include a frame 205 configured to mount to a user's head. The frame 205 is merely an example structure to which various components of the NED 200 may be mounted. Other suitable type of fixtures may be used in place of or in combination with the frame 205. In some embodiments, the frame 205 may represent a frame of eyeglasses. The NED 200 may include right-eye and left-eye display systems 210R and 210L mounted to the frame 205. The NED 200 may function as a VR device, an AR device, an MR device, or any combination thereof. In some embodiments, when the NED 200 functions as an AR or an MR device, the right-eye and left-eye display systems 210R and 210L may be entirely or partially transparent from the perspective of the user, which may provide the user with a view of a surrounding real-world environment. In some embodiments, when the NED 200 functions as a VR device, the right-eye and left-eye display systems 210R and 210L may be opaque to block the light from the real-world environment, such that the user may be immersed in the VR imagery based on computer-generated images.

The right-eye and left-eye display systems 210R and 210L may include image display components configured to generate computer-generated virtual images, and direct the virtual images into left and right display windows 215L and 215R in a field of view (“FOV”). For illustrative purposes, FIG. 2A shows that the left-eye display systems 210L may include a light source assembly (e.g., a projector) 235 coupled to the frame 205 and configured to generate an image light representing a virtual image. The right-eye and left-eye display systems 210R and 210L may be any suitable display systems. In some embodiments, the right-eye and left-eye display systems 210R and 210L may include one or more optical components with a layered structure (e.g., including a substate, one or more optical films, and a protecting film, etc.). In some embodiments, the right-eye and left-eye display systems 210R and 210L may include a light guide display system. An example of a light guide display system will be explained in FIG. 2.

As shown in FIG. 2B, the left-eye display systems 210L may also include a viewing optical system 280 and an object tracking system 290 (e.g., eye tracking system and/or face tracking system). The viewing optical system 280 may be configured to guide the image light output from the left-eye display system 210L to an exit pupil 257. The exit pupil 257 may be a location where an eye pupil 255 of an eye 260 of an user is positioned in an eye-box region 259 of the left-eye display system 210L. For example, the viewing optical system 280 may include one or more optical elements configured to, e.g., correct aberrations in an image light output from the left-eye display systems 210L, adjusting a focus of an image light output from the left-eye display systems 210L, or perform another type of optical adjustment of an image light output from the left-eye display systems 210L. Examples of the one or more optical elements may include an aperture, a Fresnel lens, a convex lens, a concave lens, a filter, any other suitable optical element that affects an image light, or a combination thereof. In some embodiments, the viewing optical system 280 may include one or more optical components with a layered structure (e.g., including a substate, one or more optical films, and a protecting film, etc.).

The object tracking system 290 may include an IR light source 291 configured to illuminate the eye 260 and/or the face, and an optical sensor 293 (e.g., a camera) configured to receive the IR light reflected by the eye 260 and generate a tracking signal relating to the eye 260 (e.g., an image of the eye 260). In some embodiments, the object tracking system 290 may also include an IR deflecting element (not shown) configured to deflect the IR light reflected by the eye 260 toward the optical sensor 293. In some embodiments, the object tracking system 290 may include one or more optical components with a layered structure (e.g., including a substate, one or more optical films, and a protecting film, etc.). In some embodiments, the NED 200 may include an adaptive dimming element which may dynamically adjust the transmittance of lights reflected by real-world objects, thereby switching the NED 200 between a VR device and an AR device or between a VR device and an MR device. In some embodiments, along with switching between the AR/MR device and the VR device, the adaptive dimming element may be used in the AR and/MR device to mitigate differences in brightness of lights reflected by real-world objects and virtual image lights.

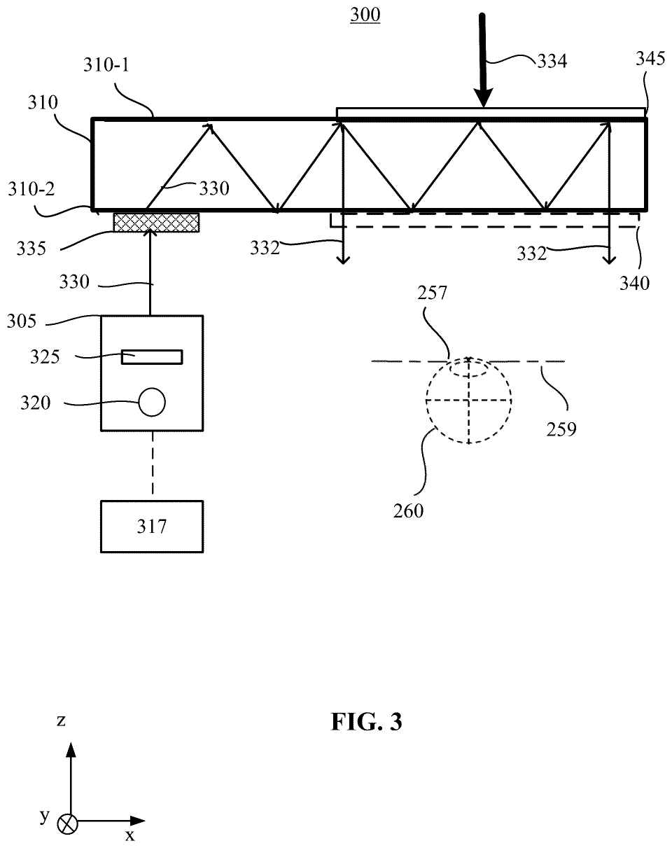

FIG. 3 illustrates an x-z sectional view of a light guide display system 300, according to an embodiment of the present disclosure. The light guide display system 300 may be a part of a system (e.g., an NED, an HUD, an HMD, a smart phone, a laptop, or a television, etc.) for VR, AR, and/or MR applications. As shown in FIG. 3, the light guide display system 300 may include a light source assembly 305, a light guide 310 coupled with an in-coupling element 335 and an out-coupling element 345, and a controller 317. The light source assembly 305 may output an image light 330 representing a virtual image, and the light guide 310 coupled with the in-coupling element 335 and the out-coupling element 345 may guide the image light 330 toward a plurality of exit pupils 257 positioned in an eye-box region 259 of the system 300.

The light source assembly 305 may include a light source 320 and an light conditioning system 325. In some embodiments, the light source 320 may be a light source configured to generate a coherent or partially coherent light. The light source 320 may include, e.g., a laser diode, a vertical cavity surface emitting laser, a light emitting diode, or a combination thereof. In some embodiments, the light source 320 may be a display panel, such as a liquid crystal display (“LCD”) panel, a liquid-crystal-on-silicon (“LCoS”) display panel, an organic light-emitting diode (“OLED”) display panel, a micro light-emitting diode (“micro-LED”) display panel, a digital light processing (“DLP”) display panel, a laser scanning display panel, or a combination thereof. In some embodiments, the light source 320 may be a self-emissive panel, such as an OLED display panel or a micro-LED display panel. In some embodiments, the light source 320 may be a display panel that is illuminated by an external source, such as an LCD panel, an LCoS display panel, or a DLP display panel. Examples of an external source may include a laser, an LED, an OLED, or a combination thereof. The light conditioning system 325 may include one or more optical components configured to condition the image light output from the light source 320, e.g., a collimating lens configure to transform or convert a linear distribution of the pixels in the display panel into an angular distribution of the pixels at the input side of the light guide 310.

The light guide 310 may receive the image light 330 at the in-coupling element 335 located at the first portion of the light guide 310. In some embodiments, the in-coupling element 335 may couple the image light 330 into a total internal reflection (“TIR”) path inside the light guide 310. The image light 330 may propagate inside the light guide 310 via TIR toward an out-coupling element 345 located at a second portion of the light guide 310. The out-coupling element 345 may be configured to couple the image light 330 out of the light guide 310 as a plurality of output lights 332 propagating toward the eye-box region 259. Each of the plurality of the output lights 332 may present substantially the same image content as the image light 330. Thus, the out-coupling element 345 may be configured to replicate the image light 330 received from the light source assembly 305 at an output side of the light guide 310 to expand an effective pupil of the light guide display assembly 300, e.g. in an x-axis direction shown in FIG. 3.

The light guide 310 may include a first surface or side 310-1 facing the real-world environment and an opposing second surface or side 310-2 facing the eye-box region 359. Each of the in-coupling element 335 and the out-coupling element 345 may be disposed at the first surface 310-1 or the second surface 310-2 of the light guide 310. In some embodiments, as shown in FIG. 3, the in-coupling element 335 may be disposed at the second surface 310-2 of the light guide 310, and the out-coupling element 345 may be disposed at the first surface 310-1 of the light guide 310. In some embodiments, the in-coupling element 335 may be disposed at the first surface 310-1 of the light guide 310. In some embodiments, the out-coupling element 345 may be disposed at the second surface 310-2 of the light guide 310. In some embodiments, both of the in-coupling element 335 and the out-coupling element 345 may be disposed at the first surface 310-1 or the second surface 310-2 of the light guide 310. In some embodiments, the in-coupling element 335 or the out-coupling element 345 may be integrally formed as a part of the light guide 310 at the corresponding surface. In some embodiments, the in-coupling element 335 or the out-coupling element 345 may be separately formed, and may be disposed at (e.g., affixed to) the corresponding surface.

In some embodiments, each of the in-coupling element 335 and the out-coupling element 345 may have a designed operating wavelength band that includes at least a portion of the visible wavelength band. In some embodiments, the designed operating wavelength band of each of the in-coupling element 335 and the out-coupling element 345 may not include the IR wavelength band. For example, each of the in-coupling element 335 and the out-coupling element 345 may be configured to deflect a visible light, and transmit an IR light without a deflection or with negligible deflection.

In some embodiments, each of the in-coupling element 335 and the out-coupling element 345 may include one or more diffraction gratings, one or more cascaded reflectors, one or more prismatic surface elements, and/or an array of holographic reflectors, or any combination thereof. In some embodiments, each of the in-coupling element 335 and the out-coupling element 345 may include one or more diffractive structures, e.g., diffraction gratings. The diffraction grating may include a surface relief grating, a volume hologram grating, or a polarization hologram grating, etc. For discussion purposes, the in-coupling element 335 and the out-coupling element 345 may also be referred to as the in-coupling grating 335 and the out-coupling grating 345, respectively. In some embodiments, a period of the in-coupling grating 335 may be configured to enable TIR of the image light 330 within the light guide 310. In some embodiments, a period of the out-coupling grating 345 may be configured to couple the image light 330 propagating inside the light guide 310 through TIR out of the light guide 310 via diffraction.

The light guide 310 may include one or more materials configured to facilitate the total internal reflection of the image light 330. The light guide 310 may include, for example, a plastic, a glass, and/or polymers. The light guide 310 may have a relatively small form factor. The light guide 310 coupled with the in-coupling element 335 and the out-coupling element 345 may also function as an image combiner (e.g., AR or MR combiner). The light guide 310 may combine the image light 332 representing a virtual image and a light 334 from the real world environment (or a real world light 334), such that the virtual image may be superimposed with real-world images. With the light guide display system 300, the physical display and electronics may be moved to a side of a front body of an NED. A substantially fully unobstructed view of the real world environment may be achieved, which enhances the AR or MR user experience.

In some embodiments, the light guide 310 may include additional elements configured to redirect, fold, and/or expand the pupil of the light source assembly 305. For example, in some embodiments, the light guide display system 300 may include a redirecting element 340 coupled to the light guide 310, and configured to redirect the image light 330 to the out-coupling element 345, such that the image light 330 is coupled out of the light guide 310 via the out-coupling element 345. In some embodiments, the redirecting element 340 may be arranged at a location of the light guide 310 opposing the location of the out-coupling element 345. For example, in some embodiments, the redirecting element 340 may be integrally formed as a part of the light guide 310 at the corresponding surface. In some embodiments, the redirecting element 340 may be separately formed and disposed at (e.g., affixed to) the corresponding surface of the light guide 310.

In some embodiments, the redirecting element 340 and the out-coupling element 345 may have a similar structure. In some embodiments, the redirecting element 340 may include one or more diffraction gratings, one or more cascaded reflectors, one or more prismatic surface elements, and/or an array of holographic reflectors, or any combination thereof. In some embodiments, the redirecting element 340 may include one or more diffractive structures, e.g., diffraction gratings. The diffraction grating may include a surface relief grating, a volume hologram grating, a polarization hologram grating (e.g., a liquid crystal polarization hologram grating), or any combination thereof. For discussion purposes, the redirecting element 340 may also be referred to as the redirecting grating 340.

In some embodiments, the redirecting element 340 and the out-coupling element 345 may be configured to replicate the image light 330 received from the light source assembly 305 at the output side of the light guide 310 in two different directions, thereby providing a two-dimensional (“2D”) expansion of the effective pupil of the light guide display assembly 300. For example, the out-coupling element 345 may be configured to replicate the image light 330 received from the light source assembly 305 at the output side of the light guide 310 to expand the effective pupil of the light guide display assembly 300, e.g. in the x-axis direction shown in FIG. 3, and the redirecting element 340 may be configured to replicate the image light 330 received from the light source assembly 305 at the output side of the light guide 310 to expand the effective pupil of the light guide display assembly 300, e.g., in the y-axis direction shown in FIG. 3.

In some embodiments, one of the redirecting grating 340 and the out-coupling grating 345 may be disposed at the first surface 310-1 of the light guide 310, and the other one of the redirecting grating 340 and the out-coupling grating 345 may be disposed at the second surface 310-2 of the light guide 310. In some embodiments, the redirecting grating 340 and the out-coupling grating 345 may have different orientations of grating fringes (or grating vectors), thereby expanding the input image light 330 in two different directions. For example, the out-coupling grating 345 may expand the image light 330 along the x-axis direction, and the redirecting grating 340 may expand the image light 330 along the y-axis direction. The out-coupling grating 345 may further couple the expanded input image light out of the light guide 310. Accordingly, the light guide display system 300 may provide 2D pupil replication (or pupil expansion) at a light output side of the light guide display system 300. In some embodiments, the redirecting grating 340 and the out-coupling grating 345 may be disposed at the same surface of the light guide 310. In addition, to expand the exit pupil (or effective pupil) of the light guide display system 300 in more than two directions, more than two gratings (or layers of diffractive structures) may be disposed at the light output region of the light guide 310.

In some embodiments, multiple functions, e.g., redirecting, folding, and/or expanding the pupil of the light generated by the light source assembly 305 may be combined into a single element, e.g. the out-coupling element 345. For example, the out-coupling element 345 itself may be configured to provide a 2D expansion of the effective pupil of the light guide display assembly 300. For example, the out-coupling grating 345 may be a 2D grating including a single grating layer or a single layer of diffractive structures.

The light guide 310, the in-coupling grating 335, the out-coupling grating 345, and/or the redirecting grating 340 may be designed to be substantially transparent in the visible spectrum. The in-coupling grating 335, the out-coupling grating 345, and/or the redirecting grating 340 may be optical films functioning as gratings. For example, the in-coupling grating 335, the out-coupling grating 345, and/or the redirecting grating 340 may be a polymer layer, e.g., a photo-polymer film, or a liquid crystal polymer film, etc. In some embodiments, protecting films may be disposed at the in-coupling grating 335, the out-coupling grating 345, and/or the redirecting grating 340 for protection purposes. In some embodiments, the light guide 310 may also be coupled to one or more additional optical films that are substantially transparent in the visible spectrum. For example, the in-coupling grating 335, the out-coupling grating 345, and/or the redirecting grating 340 may be coupled to an additional optical film.

The light guide 310 disposed with the in-coupling grating 335, the out-coupling grating 345, and/or the redirecting grating 340 may be an example of an optical component with a layered structure disclosed in the present disclosure. Such an optical component with the layered structure may be substantially optically transparent at least in the visible wavelength range (e.g., about 380 nm to about 700 nm). The optical component with the layered structure may scatter a light when the light propagates through the layered structure of the optical component. When the light scattering is inelastic, for example, Raman scattering, the light scattering may provide information of the chemical (or material) composition of the multiple layers in the optical component. When the light scattering is elastic, the light scattering may disclose structure information of the multiple layers in the optical component at different spatial scales: much smaller than the wavelength of the light (Rayleigh scattering), comparable to the wavelength of the light (Mie scattering), or much larger than the wavelength of the light (Geometric scattering).

Some elastic scattering behaviors may cause haze, which is a measurement of clarity or the “see through quality” of the optical component with the layered structure based on a reduction of sharpness. Thus, it is highly desirable to measure the light scattering of the optical component in relevant spectral ranges, ensuring that the haze of the optical component is within a predetermined range, and the optical component meets design specifications and customer expectations. It is also highly desirable to identify and visualize the sources of scattering in the optical component, e.g., whether the scattering sources are within the layers, at an interface between two neighboring layers, and/or at an interface between a layer and an outside environment (e.g., air). The identification and visualization of the scattering sources may provide guidance for the design (e.g., structures, materials, compositions, etc.) and fabrication of an optical component with reduced haze. When the optical components are fabricated during a mass production, a low-cost, highly sensitive and efficient system and method for measuring the scattering property is desirable. The disclosed system and method for measuring scattering properties of the optical components can be used in quality control process of mass production of the optical components.

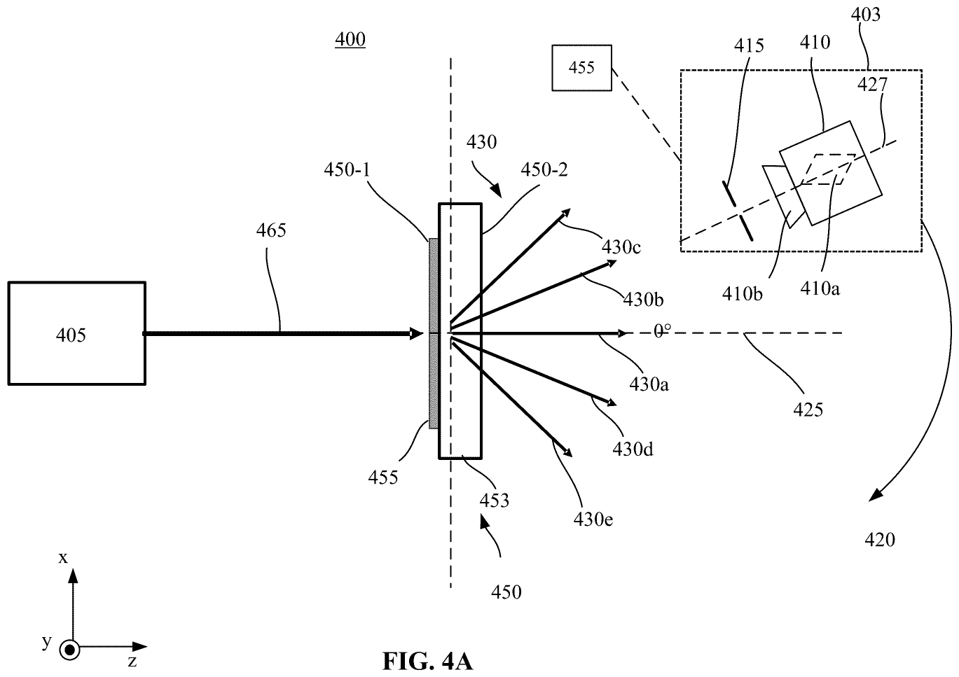

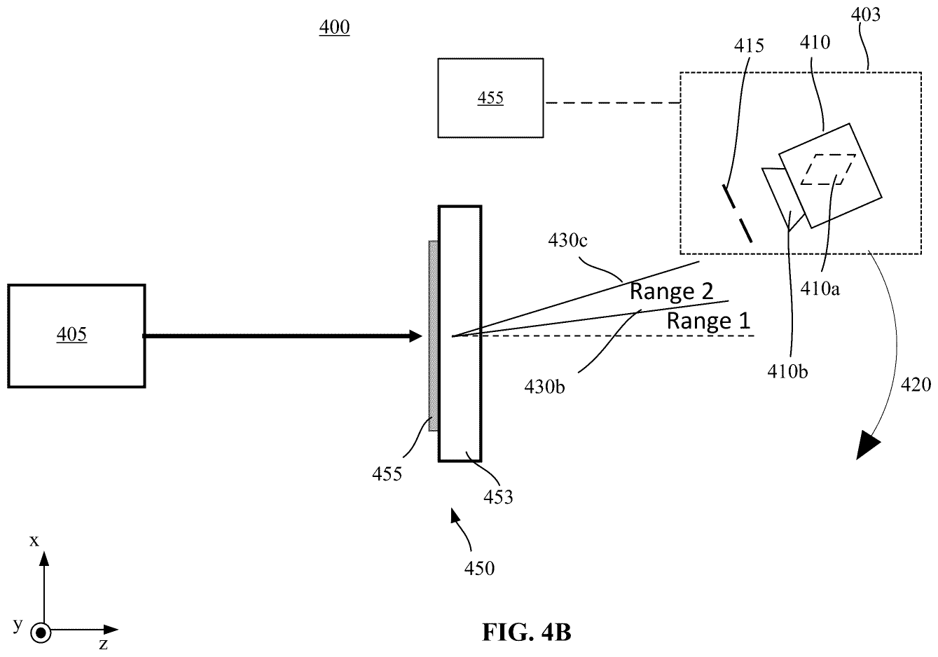

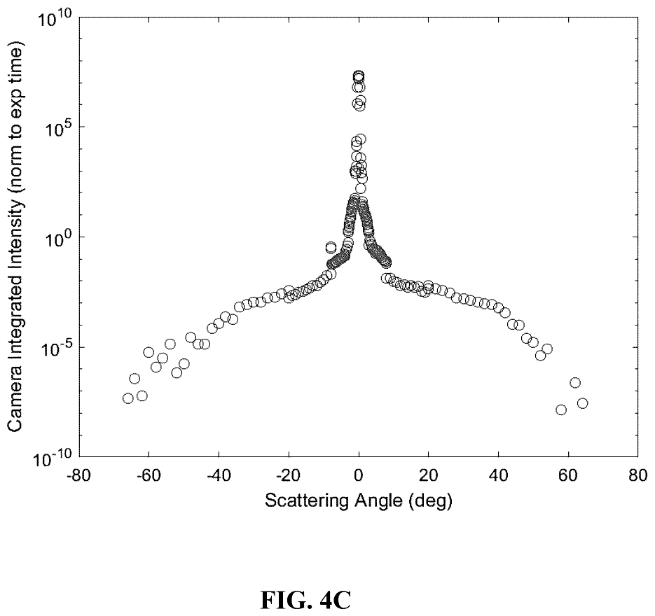

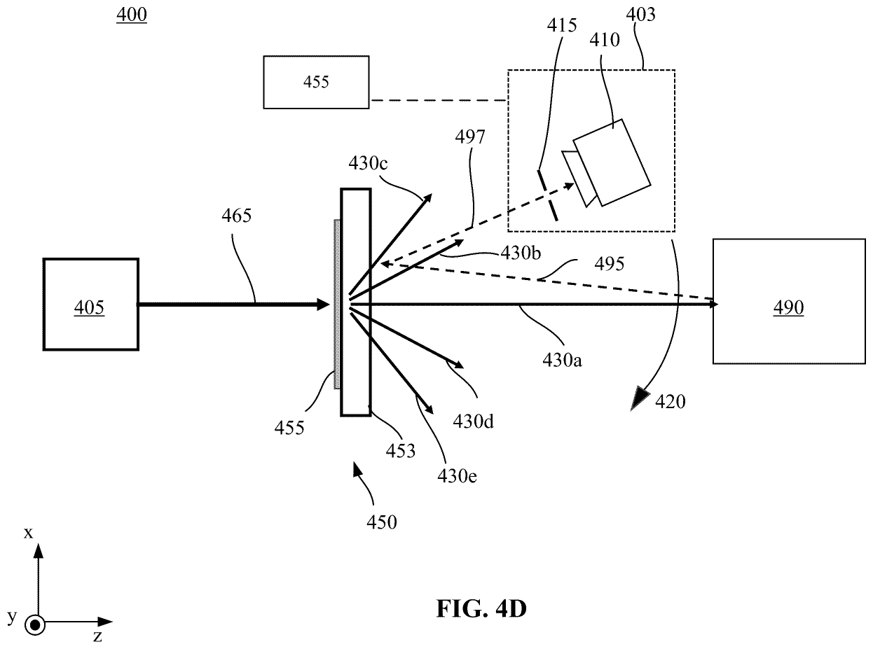

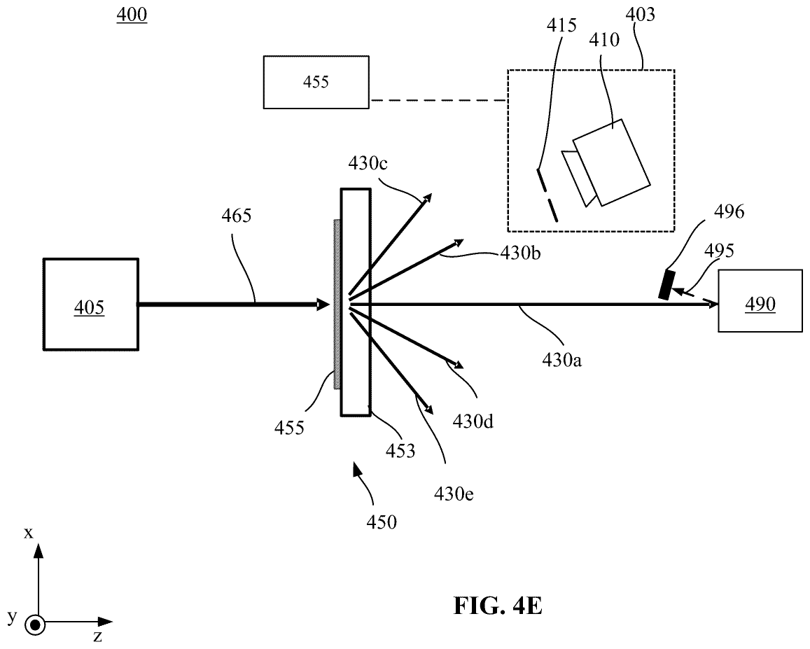

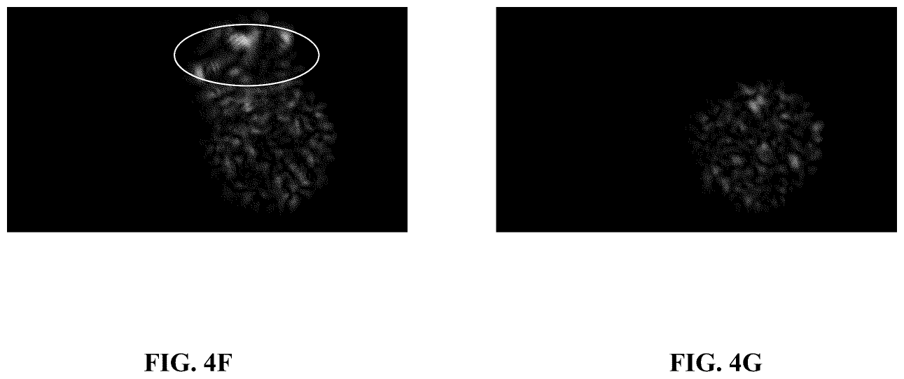

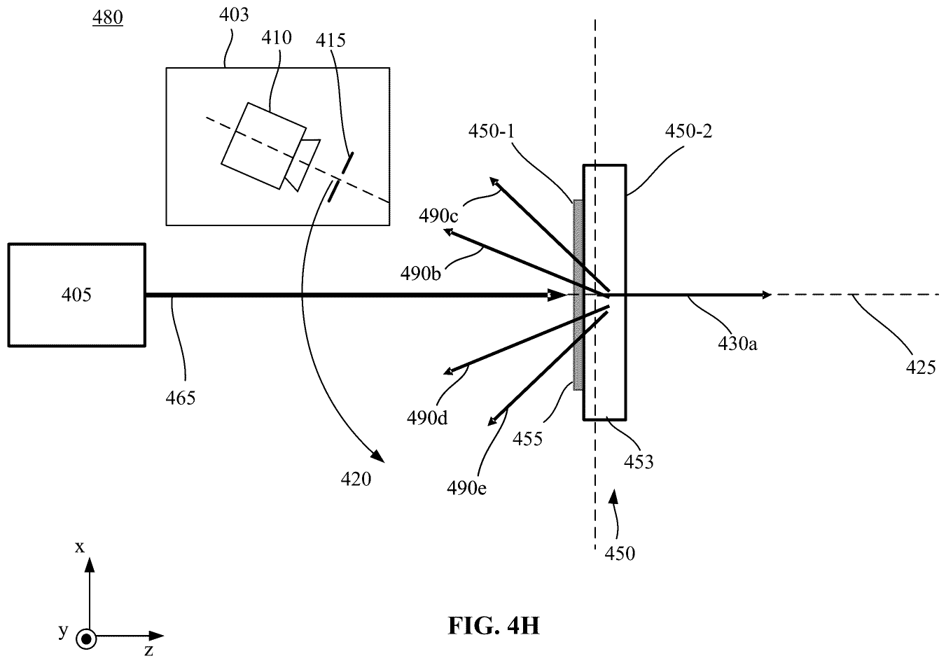

The systems and methods disclosed herein may be used for measuring any angular-dependent optical properties of an optical element or component. The angular-dependent optical properties may be angular-dependent scattering, angular-dependent diffraction, angular-dependent reflection, etc. For the purpose of illustrating the principles of the disclosed systems and methods, measurement of angular-dependent scattering intensity of an optical element/component is used as an example. FIG. 4A schematically illustrates a system 400 for measuring light scattering property (or angular scattering distribution or profile) of an optical component, according to an embodiment of the present disclosure. The system 400 may measure the angular-dependent scattering intensity of the optical component based on an imaging device (e.g., a camera with a 2D image sensor). The system 400 may be lock-in-detection free.

As shown in FIG. 4A, the system 400 may include a light source 405 and a detection assembly 403. A sample 450 may be disposed between the light source 405 and the detection assembly 403. The sample 450 may be a single-layer optical component or a multi-layer optical component (e.g., an optical component with a layered structure). For illustrative purposes, FIG. 4A shows that the sample 450 has a layered structure (i.e., multi-layer structure) having two layers of optical films, plates, or elements. For example, the sample 450 may include a first layer 453 and a second layer 455. In some embodiments, the first layer 453 may be a substrate, and the second layer 455 may be an optical film. In some embodiments, the optical film may include a liquid crystal polymer (“LCP”), and the optical film may be an LCP layer. In some embodiments, the LCP layer may include polymerized (or cross-linked) liquid crystals (“LCs”), polymer-stabilized LCs, a photo-sensitive LC polymer, or any combination thereof. The LCs may include nematic LCs, twist-bend LCs, chiral nematic LCs, smectic LCs, or any combination thereof. In some embodiments, the optical film may be a photo-sensitive polymer layer including a birefringent photo-refractive holographic material other than LCs, such as an amorphous polymer. In some embodiments, the optical film including the LCP layer or the polymer layer (e.g., amorphous polymer layer) may function as a Pancharatnam-Berry phase (“PBP”), a volume Bragg grating (“VBG”) element, or a polarization volume hologram (“PVH”) element. The PVH element may be fabricated based on various methods, such as holographic interference, laser direct writing, ink-jet printing, and various other forms of lithography. Thus, a “hologram” described herein is not limited to creation by holographic interference, or “holography.”

The optical film may be configured with a predetermined optical function. The optical film may function as a transmissive or reflective optical element, such as a prism, a lens or lens array, a grating, a polarizer, a compensation plate, or a phase retarder, etc. The optical film may include one or more layers of films. The thickness of the optical film may be within a range from several micrometers (“um”) to several hundreds of micrometers. For example, the thickness of the optical film may be within a range from 5 μm to 50 μm, 5 μm to 60 μm, 5 μm to 70 μm, 5 μm to 80 μm, 5 μm to 90 μm, 5 μm to 100 μm, 10 μm to 50 μm, 10 μm to 60 μm, 10 um to 70 μm, 10 μm to 80 μm, 10 μm to 90 μm, 10 μm to 100 μm, or 5 μm to 200 μm, etc.

The substrate (an example of the first layer 453) may provide support and protection to various layers, films, and/or structures formed thereon. In some embodiments, the substrate may be at least partially transparent in the visible wavelength range (e.g., about 380 nm to about 700 nm). In some embodiments, the substrate may be at least partially transparent in at least a portion of the infrared (“IR”) band (e.g., about 700 nm to about 2 mm). The substrate may include a suitable material that is at least partially transparent to lights of the above-listed wavelength ranges, such as, a glass, a plastic, a sapphire, or a combination thereof, etc. The substrate may be rigid, semi-rigid, flexible, or semi-flexible. The substrate may include a flat surface or a curved surface, on which the different layers or films may be formed. In some embodiments, the substrate may be a part of another optical element or device (e.g., another opto-electrical element or device), e.g., the substrate may be a solid optical lens, a part of a solid optical lens, or a light guide (or waveguide), etc. For example, the substrate (an example of the first layer 453) may be the light guide 310 shown in FIG. 3, and the optical film (an example of the second layer 455) may be the in-coupling grating 335, the out-coupling grating 345, or the redirecting grating 340.

In some embodiments, the sample 450 may include more than two layers. For example, the sample 450 may include a protecting film (not shown) disposed at the second layer 455 (e.g., optical film). In some embodiments, the sample 450 may include an alignment structure (not shown) disposed between the first layer 453 (e.g., substrate) and the second layer 455 (e.g., optical film). The alignment structure may provide a predetermined alignment pattern to align the molecules in the optical film. The alignment structure may include any suitable alignment structure, such as a photo-alignment material (“PAM”) layer, a mechanically rubbed alignment layer, an alignment layer with anisotropic nanoimprint, an anisotropic relief, or a ferroelectric or ferromagnetic material layer, etc.

The light source 405 may be configured to emit a probing beam 465 having a predetermined wavelength range (e.g., a wavelength range within the visible spectrum). The probing beam 465 may illuminate the sample 450 for the purpose of scattering measurement. In some embodiments, the light source 405 may be a laser light source configured to emit a laser beam, such as a laser diode. In some embodiments, the laser beam may be a green laser beam with a center wavelength of about 532 nm. In some embodiments, the probing beam 465 may be a collimated laser beam with a planar wavefront (also referred to as 465 for discussion purposes), propagating along an optical axis 425 of the system 400. In some embodiments, the light source 405 may include a single laser light source associated with a single laser wavelength. In some embodiments, the light source 405 may include a plurality of laser light sources associated with multiple different laser wavelengths, and the system 400 may be used to characterize the angular-dependent scattering of the sample 450 at different wavelengths.

During the scattering measurement, the sample 450 may be disposed perpendicular to the optical axis 425, or with a thickness direction of the sample 450 being arranged in parallel with the optical axis 425. In some embodiments, the sample 450 may not be disposed perpendicular to the optical axis 425, and may be tilted. The principles of the disclosed system and method for measuring the scattering property of the sample 450 may also be applicable to the situation where the sample 450 is tilted with respect to the optical axis 425.

The sample 450 may include a light input surface 450-1 and a light output surface 450-2. The light input surface 450-1 may receive the probing beam 465 output from the light source 405. The light input surface 450-1 and the light output surface 450-2 may be located at opposite sides of the sample 450. In some embodiments, the light input surface 450-1 and the light output surface 450-2 may be parallel with one another. The probing beam 465 may propagate through the sample 450, and exit the sample 450 at the light output surface 450-2 as a plurality of transmitted and scattered beams 430, including a directly transmitted beam 430a (also considered as a scattered beam with a scattering angle of 0°) and a plurality of scattered beams 430b-430e. The beams 430b-430e output from the light output surface 450-2 may be referred to as forwardly scattered beams, and the corresponding scattering may be referred to as forward scattering. The detection assembly 403 may be configured to aim toward the light output surface 450-2 to measure one or more of the beams 430a-430e output from the light output surface 450-2.

In some embodiments, the sample 450 may be mounted on a stationary holder, and the position of the sample 450 may be fixed (i.e., the sample 450 may not be movable). The detection assembly 403 may be mounted on a rotation arm or a moving stage, and may be moved around the sample 450 over a predetermined rotation range (or a measurement angular range), when the rotation arm or moving stage is controlled by a controller 455. The predetermined rotation range may be any range within −180° to 180° around the sample 450. For example, the predetermined rotation range may be −90° to 90°. The predetermined rotation range may also be referred to as a predetermined measurement angular range. For example, the detection assembly 403 may be moved around the sample 450 in a clockwise direction 420 shown in FIG. 4A, from one angular position to another angular position, such that the beams 430a-430e with different scattering angles may be detected. It is noted that for convenience of discussion and illustration, the “scattering angle” of the directly transmitted beam 430a prorogating in parallel to the optical axis 425 is 0°. The scattered beams 430b and 430c may have negative scattering angles, and the scattered beams 430d and 430e may have positive scattering angles.

An axis parallel to the thickness direction of the sample 450 and passing through the center of the sample 450 may be referred to as a reference axis. In the embodiment shown in FIG. 4A, the optical axis 425 may coincide with the reference axis. An angle formed by an optical axis 427 of the detection assembly 403 with respect to the reference axis may be defined as a rotation angle of the detection assembly 403. In some embodiments, the rotation angle of the detection assembly 403 may be a suitable angle within the range of −180° to +180°. For example, the predetermined rotation range of the detection assembly 403 may be from −90° to +90° (or a larger range) for measuring the forward scattering, or for measuring the backward scattering. The detection assembly 403 may include an imaging device 410, and a diaphragm (or an iris) 415 disposed in front of the imaging device 410. The diaphragm 415 may define an aperture with a predetermined size (e.g., a predetermined circular hole), through which a beam can reach the imaging device 410. The imaging device 410 may include an image sensor 410a, and a lens or lens array 410b disposed in front of the image sensor 410a. The image sensor 410a may be any suitable imaging sensor that generates a set of speckle pattern image data (that forms or represents an image of a speckle pattern) of one or more beams when received by the image sensor 410a. The speckle pattern may include multiple speckles, and the image sensor 410a may provide spatial information of the multiple speckles in the pattern.

In some embodiments, the imaging device 410 may be a camera (also referred to as 410 for discussion purposes), and the image sensor 410a may also be referred to as a camera sensor 410a. The image sensor 410a may be any suitable 2D image sensor, such as a charge-coupled device (“CCD”) image sensor, a complementary metal-oxide-semiconductor (“CMOS”) image sensor, an N-type metal-oxide-semiconductor (“NMOS”) image sensor, a pixelated polarized image sensor, or any other image sensors. The camera sensor 410a may include a 2D array of pixels, and thus each image generated by the camera sensor 410 at an angular position may provide 2D spatial information of speckles of a received beam. The speckles of the beam may appear in the image as a speckle pattern. Compared with a single photodiode or a photodiode array used in conventional technology, the image sensor 410a (e.g., a CCD sensor including an integrated circuit containing an array of linked capacitors) may provide an electrical output with a lower noise and a higher sensitivity. The image sensor 410a (e.g., a CCD sensor) may provide an improved performance in capturing high quality images or low-light spectral measurements.

The detection assembly 403, the diaphragm 415 and the lens (or lens array) 410b may be disposed in front of the image sensor 410a, and the lens (or lens array) 410b may be disposed between the diaphragm 415 and the image sensor 410a. In some embodiments, the image sensor 410a may include a plurality of pixels arranged in a pixel array. The diaphragm 415 may define an area (or size of an aperture) through which the image sensor 410a can receive the beams. The diaphragm 415 may reduce the stray lights that may be received by the image sensor 410a, and may control the scattering speckle size. The lens (or lens array) 410b may focus the beams onto the image sensor 410a. The diaphragm 415 and the lens (or lens array) 410b may also control the size of the speckle.

At each angular position as the detection assembly 403 is moved within the predetermined rotation range, the image sensor 410a may detect one or more of the beams 430a-430e, and generate a set of speckle pattern image data (that forms or represents an image of a speckle pattern) based on the one or more detected beams. The set of speckle pattern image data may include a set of intensity data relating to the scattered beams output from the sample 450. For discussion purposes, in FIG. 4A, at each angular position as the detection assembly 403 is moved within the predetermined rotation range, the image sensor 410a may be configured to detect a single beam of the beams 430a-430e. After the detection assembly 403 is moved around the sample 450 over the predetermined rotation range, the image sensor 410a may generate a series of sets of speckle pattern image data (representing a series of images of speckle patterns) based on the respective received beams 430a-430e with different scattering angles. For example, the image sensor 410a may generate five sets of speckle pattern image data based on the received beams 430a-430e. The sets of speckle pattern image data may be processed by the controller 455. The controller 455 may include any suitable processor for processing data. For example, the controller 455 may process the sets of speckle pattern image data to generate a plot of scattering intensity versus scattering angle.

That is, at each angular position as the detection assembly 403 is moved within the predetermined rotation range, the image sensor 410a may detect one of the beams 430a-430e and generate a corresponding set of speckle pattern image data (that forms or represents an image of a speckle pattern). Based on the set of speckle pattern image data, the controller 455 may calculate a light scattering intensity corresponding to the angular position of the detection assembly 403 (note the angular position corresponds to a scattering angle). Multiple light intensities and multiple scattering angles (within the predetermined rotation range) may be plotted in a same figure to show the relationship between the scattering intensity and the scattering angle. The plot reflects the scattering property of the sample 450, and can indicate whether the scattering property of the sample 450 meets a predetermined scattering criterion, or whether there is any irregularity in the light intensity at which scattering angle. The plot may be used to provide guidance on the design (such as material composition) of the sample 450. The plot may also provide information on the structural integrity of the sample 450, etc.

In the disclosed embodiments, the imaging device 410 may have an improved performance compared to a single photodiode (e.g., 110 shown in FIG. 1) included in a conventional system. For example, the image sensor 410a may provide a wider dynamic measurement range as compared to the single photodiode used in the conventional system (e.g., the single photodiode 110 used in the conventional system 100 shown in FIG. 1). For example, the exposure time of the image sensor 410a may range from about 1 μs (micro-second) to 10 s (second), providing 7 orders of magnitude of adjustments. In some embodiments, the image sensor 410a may provide 8-bit depth, corresponding to a range of 0 to 2⁸ (=256), providing 2 orders of magnitude. The number of pixels can be about 10⁷, providing 7 orders of magnitude. In total, the image sensor 410a can support a 16-order of magnitude measurement dynamic range. In some embodiments, the image sensor 410a may provide 10-bit depth, 12-bit depth, or even higher depth, increasing the dynamic range of the image sensor 410a.

Compared to the single photodiode used in the conventional system, the image sensor 410a has advantages of high measurement sensitivity due to the higher light collection efficiency. The image sensor 410a may have an active light collection area of at least 2*2 cm², whereas a typical photodiode used in the conventional system has an active light collection area of about 1*1 mm². Thus, the light collection area provided by the image sensor 410a is at least 400 times of that of a typical photodiode. This translates into an about 400 times of higher light collection efficiency.

As the image sensor 410a includes a 2D array of pixels, the image sensor 410a may provide spatial information of speckles, enabling troubleshooting analysis to identify a stray light that may cause irregularities in measured intensity data (as reflected in generated images). With the image sensor 410a, the stray light may be visualized in the image. Troubleshooting for any irregular speckles in the generated image which may be caused by the stray light may be performed. The source of the stray light may be identified, measures may be taken to mitigate the effect caused by the stray light, and the scattering measurements may be performed after the effect of the stray light is mitigated. Ways to mitigate the effect of a stray light may include, for example, removing a light source that emits the stray light, blocking or absorbing the stray light so that the stray light is not incident onto the sample 450, and hence is not received by the image sensor 410a. Thus, with the effect of the stray light mitigated, the scattering measurement may be more accurate and reliable. The disclosed system 400 does not require the lock-in detection, the light source modulation, and source-detector synchronization, which are typically used in the conventional system. Thus, the entire system 400 may be low-cost, high detection sensitivity, high detection efficiency, and easy for troubleshooting of stray lights, and may be adopted in quality control process of mass production of optical components.

The processes for performing the scattering measurement using the system 400 shown in FIG. 4A may include a first step of exposure time pre-setting, a second step of dark frame characterization, and a third step of data acquisition, dark frame subtraction, and data processing. In some embodiments, these processes or steps may be performed automatically by the controller 455 and the various elements or components included in the system 400 that may be controlled by the controller 455. In some embodiments, one or more steps may be manually performed by an operator of the system 400.

As shown in FIG. 4B, the first step of exposure time pre-setting may be performed to pre-set the exposure time of the image sensor 410a for each angular sub-range of the predetermined rotation range. For example, presuming that the predetermined rotation range (also referred to as the overall measurement angular range) of the detection assembly 403 is from −90° to +90° (which may be any other ranges within −180° to 180°), the predetermined rotation range may be divided into a plurality of angular sub-ranges (labeled as “Range 1,” “Range 2,” . . . “Range n”). The respective angular spans for the respective angular sub-range may be determined by the aperture size of the diaphragm 415, and the distance from the image sensor 410a to the sample 450. In other words, the angular resolution of the scattering measurement may be determined by the aperture size of the diaphragm 415, and the distance from the image sensor 410a to the sample 450. In some embodiments, in the positive angle range (e.g., from 0° or +90°), the first angular sub-range may be 0° to 1°, the second angular sub-range may be 1° to 5°, the third angular sub-range may be 5° to 10°, etc. The negative angle range may be similarly divided. Each angular sub-range may have the same angular span, or may have different angular spans. In some embodiments, the angular sub-ranges closer to 0° may have narrower angular spans, and angular sub-ranges closer to −90° or +90° may have wider angular spans.

Within each angular sub-range, one or more specific angular positions may be selected for the detection assembly 403. For example, presuming that one angular position is selected for each sub-range, in Range 1 (e.g., 0° to 1°), an angular position of 0°, 0.5°, or 1° may be selected, and in Range 2 (e.g., 1° to 5°), an angular position of 2°, 3°, 4°, or 5° may be selected. Similar angular position selections may be made for other angular sub-ranges. The detection assembly 403 may be rotated or moved around the sample 450 along the direction 420 to each selected angular position. At each angular position, an exposure time of the image sensor 410a may be determined. In some embodiments, the exposure time may be used for any angular position within the same specific angular sub-range in the subsequent actual scattering measurement of the sample 450. In some embodiments, the pre-set exposure times for different angular sub-ranges may be different. In some embodiments, at least two of the pre-set exposure times for the respective angular sub-ranges may be different, or at least two of the pre-set exposure times for the respective angular sub-ranges may be the same.

After initial exposure times are determined, in some embodiments, the actual scattering measurement may be preliminarily performed to check for irregularities, i.e., whether any exposure time is too short or too long that may cause irregular or undesirable exposure in the image generated based on the received beams 430a-403e. If any irregularity is detected in the generated image, the processes of determining exposure times may be repeated to refine or adjust the exposure times, until a satisfactory set of exposure times are determined for the subsequent actual scattering measurement of the sample 450. In some embodiments, the processes of checking for irregularities may be omitted, and the initial exposure times may be directly used as the final exposure times. The first step of exposure time pre-setting may also be automated by predetermined algorithms or programs.

For example, the final exposure time for a first angular sub-range, “Range 1” (e.g., 0° to 1°), may be set as 10 μs, the final exposure time for a second angular sub-range, “Range 2” (e.g., 1° to 5°), may be set as 1 ms, and the final exposure time for a third angular sub-range, “Range 3” (e.g., 5° to 10°), may be set as 5 ms, so on. After an exposure time is determined for an angular sub-range, during the subsequent actual scattering measurement, even if multiple angular positions are selected within the same angular sub-range, the same exposure time may be used for the multiple angular positions when measuring scattering.

The determination of the exposure time for the respective angular sub-ranges may be based on any suitable method. For example, at each angular sub-range (e.g., 5° to 10°), the imaging device 410 may be moved to a single angular position selected within that angular sub-range to determine an exposure time as the exposure time for any angular positions within the angular sub-range. In some embodiments, the histogram captured by the image sensor 410a may be analyzed by the controller 455 using a suitable algorithm to determine an exposure time. In some embodiments, the exposure time may be determined according to a working range of the image sensor 410a within which usable data can be extracted, and the pixel value of the image sensor 410a (or the light intensity received by the image sensor 410a). The working range of the image sensor 410a may be a range between a maximum intensity value and a minimum intensity value that can be acquired by the image sensor 410a.

When the light intensity detected by the pixel of the image sensor 410a is at the maximum intensity value or higher (saturation), the pixel in the capture image may appear white, whereas when the light intensity detected by the pixel of the image sensor 410a is at the minimum intensity value or lower, the pixel in the captures image may appear black. The light intensity detected by the pixel of the image sensor 410a may be determined, in part, by the number of photons received by the pixel, the energy of a single photon, and the exposure time. In some embodiments, at the angular position within the specific angular sub-range, the exposure time may be set such that the light intensity detected by the pixels in the image sensor 410a may be limited to be within a predetermined smaller sub-range of the total working range of the camera sensor 410a (referred to as a predetermined detection range). When a detected light intensity is within the predetermined detection range, the image sensor 410a may provide a good contrast ratio and a good signal-to-noise ratio. For example, a lower limit of the predetermined detection range may greater than the minimum intensity value and equal to or greater than a first percentage (e.g., 30%, 35%, 40%, or 45%, etc.) of the maximum intensity value, and an upper limit of the predetermined smaller sub-range may be equal to or smaller than a second predetermined percentage (e.g., 70%, 65%, 60%, or 55%, etc.) of the maximum intensity value. The second percentage is greater than the first percentage.

In some embodiments, to determine the exposure time for the respective angular sub-range, two or more angular positions within the angular sub-range may be selected. An exposure time may be determined for each of the two or more angular positions. An average exposure time or a median exposure time determined based on the two or more exposure times corresponding to the two or more angular positions may be used as the exposure time for the angular sub-range. The number of angular positions to be selected for determining the exposure time for each angular sub-range may depend on the angular span of the angular sub-range, the aperture size of the diaphragm 415, and the distance from the image sensor 410a to the sample 450. In some embodiments, the controller 455 may control the movement of the detection assembly 403, and may determine the exposure times for the angular sub-ranges automatically based on pre-programmed methods for determining the exposure times.

After the exposure times are determined and pre-set in the image sensor 410a for each angular sub-range, the second step of dark frame characterization may be performed for removing the ambient light in the environment and the intrinsic noise of the image sensor 410a. Referring to FIG. 4B, to perform the step of dark frame characterization, the light source 405 may be shut down or turned off. The detection assembly 403 may be moved through different angular sub-ranges around the sample 450 within the predetermined rotation range, and may use the corresponding exposure time at each measurement angular position selected within each angular sub-range to generate a plurality of sets of dark frame image data (which may represent a plurality of sets of dark frame images). Each set of dark frame image data may include a set of dark frame light intensity data.

One or more measurement angular positions may be selected within each angular sub-range to generate the set of dark frame image data for each angular sub-range. In some embodiments, for each angular sub-range, the imaging device 410 may be moved to a single angular position, and obtain a single set of dark frame image data as the set of data frame image data for this angular sub-range. In some embodiments, the imaging device 410 may be moved to multiple angular positions within each angular sub-range, obtain multiple sets of dark frame image data at these angular positions, and determine an average dark frame intensity by averaging the multiple sets of dark frame image data obtained at these angular positions. The average set of dark frame image data may be used as the set of dark frame image data for the angular sub-range. The number of angular positions to be selected for the dark frame characterization processes at each angular sub-range may be determined based on the angular span of the angular sub-range, the aperture size of the diaphragm 415, and the distance from the image sensor 410a to the sample 450. The set of dark frame image data (that includes the dark frame light intensity) for the angular sub-range may reflect the effects of the ambient light in the environment and the intrinsic noise of the image sensor 410a.

The third step of data acquisition, dark frame subtraction, and data processing may be performed after the second step of dark frame characterization is performed. In the third step, an actual scattering measurement of the sample 450 may be performed. Still referring to FIG. 4B, the light source 405 may be turned on. The detection assembly 403 may be moved (e.g., rotated) along the direction 420 from one angular sub-range to another within the predetermined rotation range. One or more than one angular position within each angular sub-range (e.g., Range 1, Range 2, . . . ) may be selected for generating the set of speckle pattern image data (or capturing the image of the speckle pattern) of a detected beam. The number of angular positions to be selected for measuring the scattering light intensity for each angular sub-range may depend on the angular span of the angular sub-range, the aperture size of the diaphragm 415, and the distance from the image sensor 410a to the sample 450. The angular positions used in the actual scattering measurement may be the same as the angular positions used in the dark frame characterization.

At a selected angular position within an angular sub-range, the image sensor 410a may be exposed to the beam passing through the diaphragm 415 for the corresponding pre-set exposure time, and may generate a set of speckle pattern image data (that forms or represents an image of a speckle pattern) based on the detected beam. The controller 415 may subtract the set of dark frame image data from the corresponding set of speckle pattern image data. The set of speckle pattern image data may include a first set of intensity data, and the set of dark frame image data may include a second set of intensity data. For example, the controller 415 may subtract respective pixel values of the second set of intensity data from the corresponding respective pixel values of the first set of intensity data to obtain a third set of intensity data. The controller 415 may further process the third set of intensity data according to a suitable algorithm to obtain a scattering intensity (or scattering intensity data) at the corresponding angular sub-range. Then the controller 415 may scale the scattering intensity at the corresponding angular sub-range with the exposure time of the corresponding angular sub-range, and obtain a scattering intensity per time unit for the corresponding angular sub-range.

After the detection assembly 403 is moved around the sample 450 along the direction 420 over the entire predetermined rotation range (or a measurement angular range), a plurality of sets of speckle pattern image data may be generated by the image sensor 410a. Accordingly, a plurality of scattering intensities per time unit for respective angular sub-ranges may be obtained, which may be used to generate a plot of scattering intensity (measured at each angular position within each angular sub-range) versus scattering angle. The scattering angle corresponds to the angle at the angular position, where the image of the speckle pattern is generated by the image sensor 410a.

An exemplary algorithm for processing the third set of intensity data to obtain the scattering intensity at the corresponding angular sub-range is explained in the following. The exemplary algorithm may calculate the average number of photons in a single speckle in the image of the speckle pattern for evaluating the scattering intensity at the respective angular sub-range. In some embodiments, the diaphragm 415 may define an area (A) in the captured image of the speckle pattern. Within the area A, the number (N) of speckles may be counted (e.g., automatically recognized by a processor included in the controller 455 through a suitable image pattern recognition algorithm). The average speckle size may be calculated, e.g., by the processor included in the controller 455, as A/N. The total number of pixels (P) in the area A in the captured image is presumed to be a known number. Thus, the total pixels in the average speckle size may be calculated, e.g., by the processor included in the controller 455, as (P/A)*(A/N)=P/N. The total intensity It detected by an average speckle having the average speckle size may be calculated, e.g., by the processor included in the controller 455, as Iₜ=I₀*P/N, where I₀ is the average pixel value (or pixel intensity) for the area A.

The average pixel value I₀ for the area A may be measured using the system 400 without inserting the sample 450. For example, a single mode laser may emit a fixed number of photons in one mode toward the image sensor 410a, e.g., 10¹⁰ of photons in 0.1 second. As the total number of pixels (P) in the area A is presumed to be a known number, the average number of photons per pixel per time unit (e.g., second) may be determined. Then the average pixel optical power O₀ received per time unit (e.g., second) may be a product of the average number of photons per pixel per time unit and the energy of a single photon. The average pixel value Io may be the average pixel optical power O₀ received per time unit (e.g., second) divided by the pixel size.

In some embodiments, when a single selected angular position within the angular sub-range is used for generating the set of speckle pattern image data (that forms or represents the image of speckle pattern), the total intensity Io detected by the average speckle may be used as the light intensity detected by the corresponding angular sub-range (e.g., Range 1, Range 2, or Range 3, etc.). In some embodiments, when more than one selected angular position within an angular sub-range is used for generating sets of speckle pattern image data (that form or represent the images of speckle pattern), more than one total intensity It may be determined for the angular sub-range, and an average total intensity may be used as the light intensity detected by the corresponding angular sub-range (e.g., Range 1, Range 2, or Range 3, etc.).

FIG. 4C shows an example plot of the scattering intensity versus the scattering angle, showing the scattering properties of the sample 450. In FIG. 4C, the light intensity measured at the respective angular sub-ranges corresponding to different scattering angles may be normalized with respect to the respective exposure times set for the respective angular sub-ranges. The scattering measurement (e.g., the intensity versus scattering angle plots) may be analyzed by the controller 455 to determine guidance for product quality control of the sample 450 in mass production. For example, the scattering measurement may be analyzed to provide guidance on how to adjust the composition of the material for fabricating the sample 450, and on how to adjust the structure of the sample 450 such that the sample 450 may possess a desirable scattering optical property.

FIGS. 4D and 4E illustrate a principle for troubleshooting irregularities appearing in the scattering intensity data obtained via the system 400 shown in FIG. 4A, according to an embodiment of the present disclosure. As an example, FIGS. 4D and 4E illustrate a troubleshooting of stray lights in the system 400 shown in FIG. 4A. In some situations, a stray light other than the probing beam 465 may be received by the imaging sensor 410a. A stray light may be any light that is incident onto the sample 450 from an unintended light source or an unintended object. In the system 400, a stray light may be a light incident onto the sample 450 other than the probing beam 465. The stray light may cause noise, affecting the accuracy of the scattering measurement of the sample, 450. Troubleshooting of stray lights may be challenging for the conventional system with the lock-in-detection technique.

The disclosed system 400 may provide a solution for troubleshooting of stray lights in the system, and an identification of a stray light source. For example, in some applications, as shown in FIG. 4D, a beam stopper 490 may be placed in the system 400. The beam stopper 490 may be disposed on the optical path of the beam 430a, i.e., on the optical axis 425. The beam stopper 490 may be used to stop the transmission of the beam 430a beyond a certain point on the optical axis 425, such that the directly transmitted beam 430a may not be accidentally incident onto an object or a person. FIG. 4F is a sample image acquired by the system 400 shown in FIG. 4A with the beam stopper 490 (i.e., before the troubling shooting). FIG. 4F shows an image captured by the imaging device 410 at a certain angular position (e.g., 30°) based on one of the beams 430a-430e directly transmitted or scattered by the sample 450 having a corresponding scattering angle (e.g., 30°). The image shows a speckle pattern of the received beam. In FIG. 4F, the upper speckles (or beam spots) roughly indicated by the circle appear different (e.g., brighter, larger) from the remaining speckles on the image, indicating that there may be an irregularity caused by a stray light. That is, some speckles may be caused by a stray light, rather than by one of the beams 430a-430e.

Referring to FIG. 4D, as the imaging device 410 that provides 2D information of the speckles in the captured image, one may identify possible sources that may generate the stray light incident onto an upper portion of the image sensor 410a. One may find the stray light may be generated by the beam stopper 490. For example, the beam stopper 490 may reflect at least a portion of the beam 430a back to the sample 450 as a beam 495 (a stray light). The beam 495 may be incident onto the sample 450, and the sample 450 may reflect (e.g., through scattering) the beam 495 as a beam 497 propagating toward the detection assembly 403. Thus, the beams received by the imaging device 410 may include a beam (one of 430a to 430e) directly transmitted through or scattered by the sample 450 based on the probing beam 465 incident onto the sample 450, and a beam (i.e., the beam 497) based on a stray light (i.e., the beam 495) incident onto the sample 450.

To verify the presumption that the stray light is generated by the beam stopper 490, the beam stopper 490 may be removed, or the orientation of the beam stopper 490 may be changed, or another beam stopper (referred to as a second beam stopper) 496 may be disposed at a suitable location in front of the beam stopper (referred to as a first beam stopper) 490 to absorb or block the beam 495 (as shown in FIG. 4E), such that the beam 495 may not be incident onto the sample 450, and may not be received by the imaging device 410. The imaging device 410 may generate image data representing one or more images with the same setting of other parameters (e.g., angular position, exposure time). FIG. 4G is a sample image acquired by the system 400 shown in FIG. 4A with the first beam stopper 490 and the second beam stopper 496 (i.e., after the troubling shooting). FIG. 4G shows an image of speckle pattern captured by the imaging device 410 at the same angular position (e.g., 30°). FIG. 4G shows that after placing the second beam stopper 496 in front of the first beam stopper 490, the generated image does not have the upper speckles (or beam spots) that appear different (e.g., brighter, larger) from the remaining beam spots.

Comparing FIG. 4F and FIG. 4G, after placing the second beam stopper 496 in front of the first beam stopper 490, the generated image shown in FIG. 4G does not have the upper speckles (or beam spots) that appear different (e.g., brighter, larger) from the remaining beam spots shown in FIG. 4F, which may reveal that it is the beam stopper 490 that has caused the irregular beam spots indicated by the circle in FIG. 4F. Thus, the beam stopper 490 may be the source of the stray light.

With the use of the imaging device 410 that provides 2D information of the speckles in the generated image, the adverse effect of the stray light on the scattering measurement of the sample 450 may be visualized in the captured image, providing an easy identification of the “noise” intensity data caused by the stray light. With the disclosed system and method, a troubleshooting process may be conveniently performed to find out the stray light source that causes the irregularity. With the adverse effect of the stray light mitigated, the measured scattering intensity of the sample 450 may be more accurate and reliable.

Although the above descriptions use forward scattering as an example, a system similar to those shown in FIG. 4A may also be used for measuring backward scattering, with some modification to the configuration, as shown in FIG. 4H. As shown in FIG. 4H, to measure the backward scattering (e.g., scattered beams 490b, 490c, 490d, and 490e at different scattering angles) via a system 480, the detection assembly 403 and the light source 405 may be disposed at the same side of the sample 450. The descriptions relating to the forward scattering also apply to the backward scattering. A rotation arm or moving stage on which the detection assembly 403 is mounted may be configured such that as the detection assembly 403 is moved along the direction 420, the detection assembly 403 may not block the probing beam 465 from being incident onto the sample 450.

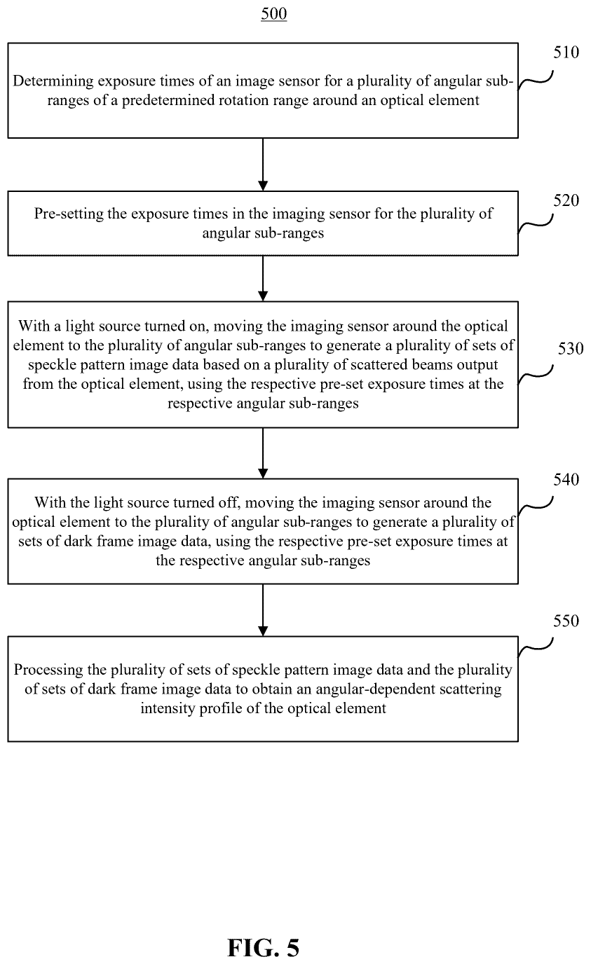

The present disclosure also provides a method for measuring an angular-dependent scattering of an optical element or component. The method may be performed by one or more components included in the disclosed system. Descriptions of the components, structures, and/or functions can refer to the above descriptions rendered in connection with FIGS. 4A-4H. FIG. 5 is a flowchart illustrating a method 500 for measuring the scattering of an optical element or component, according to an embodiment of the present disclosure.

As shown in FIG. 5, the method 500 may include determining a plurality of exposure times of an imaging sensor for a plurality of angular sub-ranges of a predetermined rotation range around an optical element (step 510). The predetermined rotation range is a range in which the image sensor may be moved around the optical element to be tested for scattering property. The imaging sensor may be rotatable (e.g., by being mounted to a rotation stage or movable stage) around the optical element from one angular sub-range to another angular sub-range within the predetermined rotation range. The imaging sensor may be a camera sensor that includes a 2D array of pixels for imaging. The optical element may be illuminated by a probing beam generated by a light source. The optical element may directly transmit and scatter the probing beam in various scattering angles as various scattered beams. The image sensor may receive the scattered beams at various angular positions in the angular sub-ranges.

The rotation predetermined range may be divided into the plurality of angular sub-ranges. For example, the predetermined rotation range may be −90° to +90°, and the plurality of angular sub-ranges may include a first sub-range from 0° to 1°, a second sub-range from 1° to 5°, a third sub-range from 5° to 10°, a fourth sub-range from 10° to 15°, . . . , etc. The imaging sensor may be rotated (or moved in a rotation direction) to one or more angular positions within each of the plurality of angular sub-ranges (a single angular position is used as an example). When the imaging sensor is positioned within each of the angular sub-ranges, an exposure time may be determined for the imaging sensor to generate a set of speckle pattern image data (that forms or represents an image of speckle pattern). The detailed process for determining the exposure times for the receptive angular sub-ranges can refer to the above descriptions.

The method 500 may also include, based on the determined exposure times for the receptive angular sub-ranges, pre-setting the exposure times in the imaging sensor for the plurality of angular sub-ranges (step 520). In some embodiments, the step 520 may be omitted. The method 500 may also include, with the light source turned on, moving the imaging sensor around the optical element to the plurality of angular sub-ranges to generate a plurality of sets of speckle pattern image data based on a plurality of scattered beams output from the optical element, using the respective pre-set exposure times at the respective angular sub-ranges (step 530). The respective sets of speckle pattern image data may include respective first sets of intensity data relating to the respective scattered beams output from the optical element. For example, the imaging sensor may be moved from a first angular position within the first angular sub-range to a second angular position within the second angular sub-range. At the first angular position, the imaging sensor may generate a first set of speckle pattern image data based on a first scattered beam with a first scattering angle within the first angular sub-range, using a first pre-set exposure time for the first angular sub-range. At the second angular position, the imaging sensor may generate a second set of speckle pattern image data of a second scattered beam with a second scattering angle within the second angular sub-range, using a second pre-set exposure time for the second angular sub-range.

The method 500 may also include, with a light source turned off, moving the imaging sensor around the optical element to the plurality of angular sub-ranges to generate a plurality of sets of dark frame image data, using the respective pre-set exposure times at the respective angular sub-ranges (step 540). The respective sets of dark frame image data may include respective second sets of intensity data relating to the ambient light in the environment and the intrinsic noise of the imaging sensor. For example, with the light source turned off, the imaging sensor may be moved from the first angular position within the first angular sub-range to the second angular position within the second angular sub-range. At the first angular position, the imaging sensor may generate a first set of dark frame image data, using the first pre-set exposure time for the first angular sub-range. At the second angular position, the imaging sensor may record a second set of dark frame image data, using the second pre-set exposure time for the second angular sub-range.

The method 500 may include processing the plurality of sets of speckle pattern image data and the plurality of sets of dark frame image data to obtain an angular-dependent scattering intensity profile of the optical element (step 550). For example, the step 550 may include subtracting the respective second sets of intensity data from the corresponding respective first sets of intensity data to obtain a plurality of third sets of intensity data for the plurality of scattered beams output from the optical element. The step 550 may also include normalizing the respective third sets of intensity data by the corresponding respective exposure times. For example, for the first scattered beam, a second set of intensity data (or the first set of dark frame image data) may be subtracted from a first set of intensity data (or the first set of speckle pattern image data) to obtain a third set of intensity data. The third set of intensity data of the first scattered beam may be normalized by the first pre-set exposure time for the first angular sub-range. For the second scattered beam, a second set of intensity data (or the second set of dark frame image data) may be subtracted from a first set of intensity data (or the second set of speckle pattern image data) to obtain a third set of intensity data. The third set of intensity data of the second scattered beam may be normalized by the second pre-set exposure time for the second angular sub-range. The step 550 may also include processing the normalized third sets of intensity data to obtain the angular-dependent scattering intensity profile of the optical element according to a predetermined algorithm.

The method 500 may include other steps or processes not shown in FIG. 5. For example, the method 500 may include processing the normalized third sets of intensity data to obtain suggestions, guidelines, or recommendations for changing the composition of the material(s) from which the optical element is fabricated, or to change the structure of the optical element. In some embodiments, the method 500 may also include analyzing the sets of speckle pattern image data, and identifying and removing light intensity data corresponding to a stray light before processing the plurality of sets of speckle pattern image data and the plurality of sets of dark frame image data to obtain the angular-dependent scattering intensity profile of the optical element. In some embodiments, the light intensity data caused by the stray light may be removed from at least one first set of intensity data.

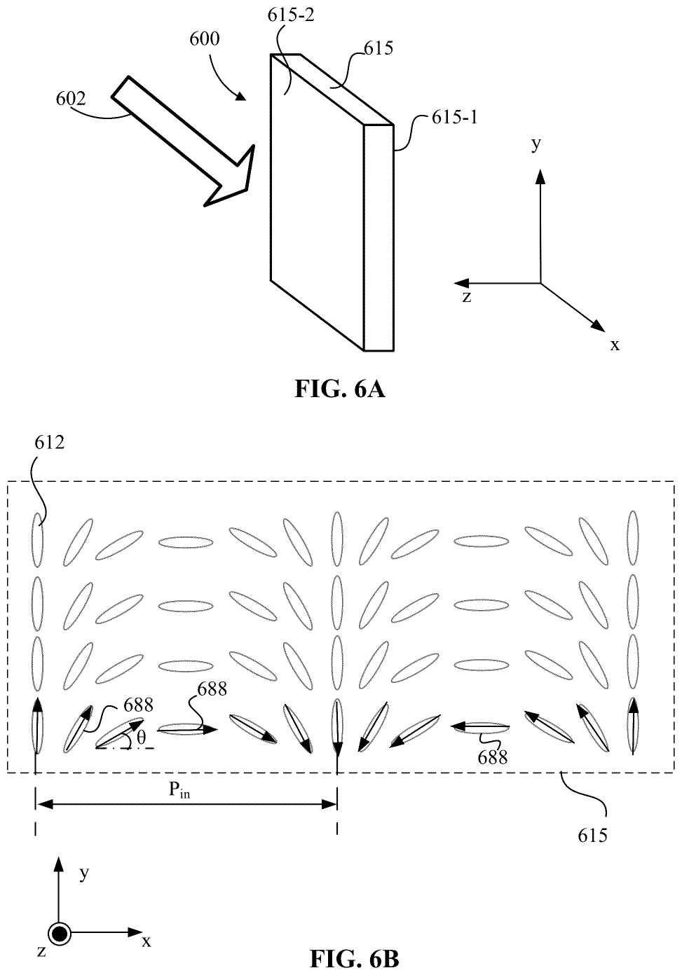

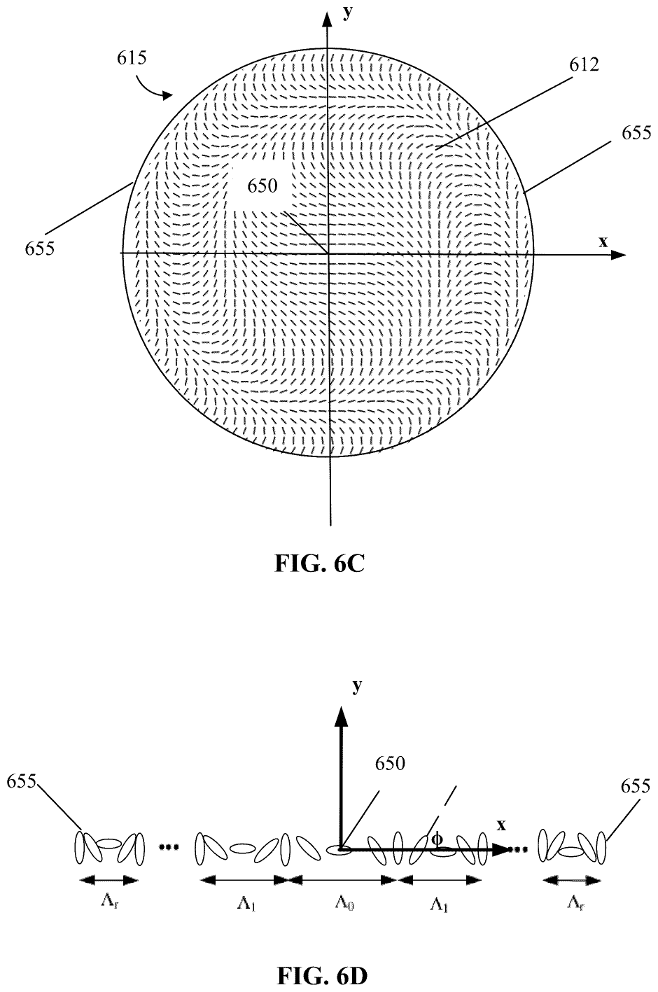

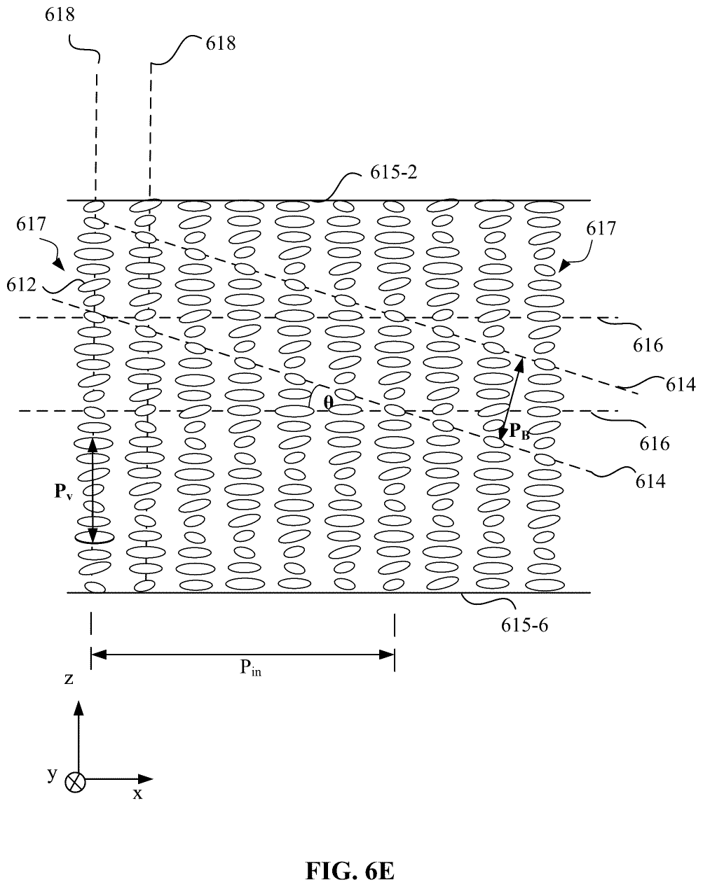

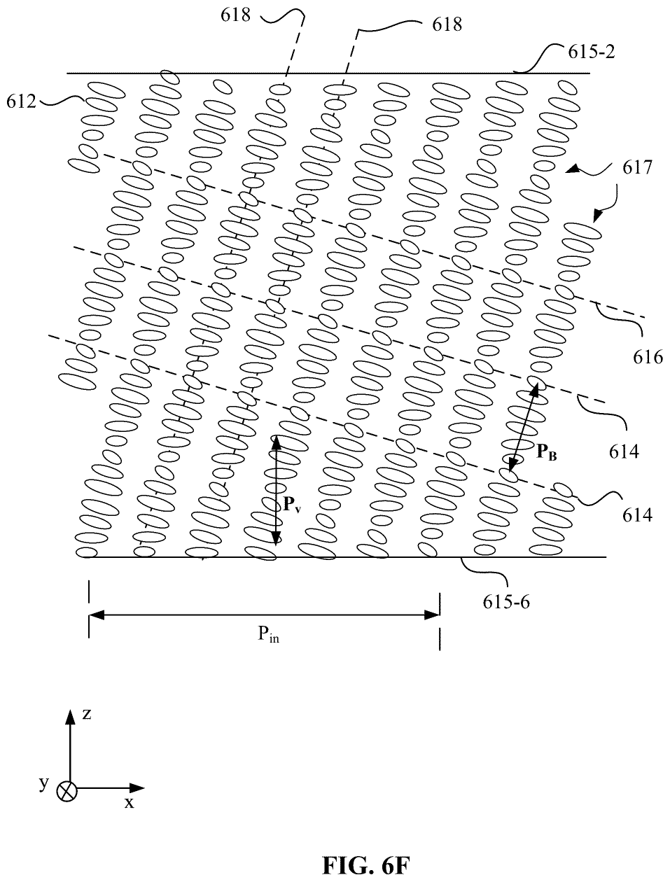

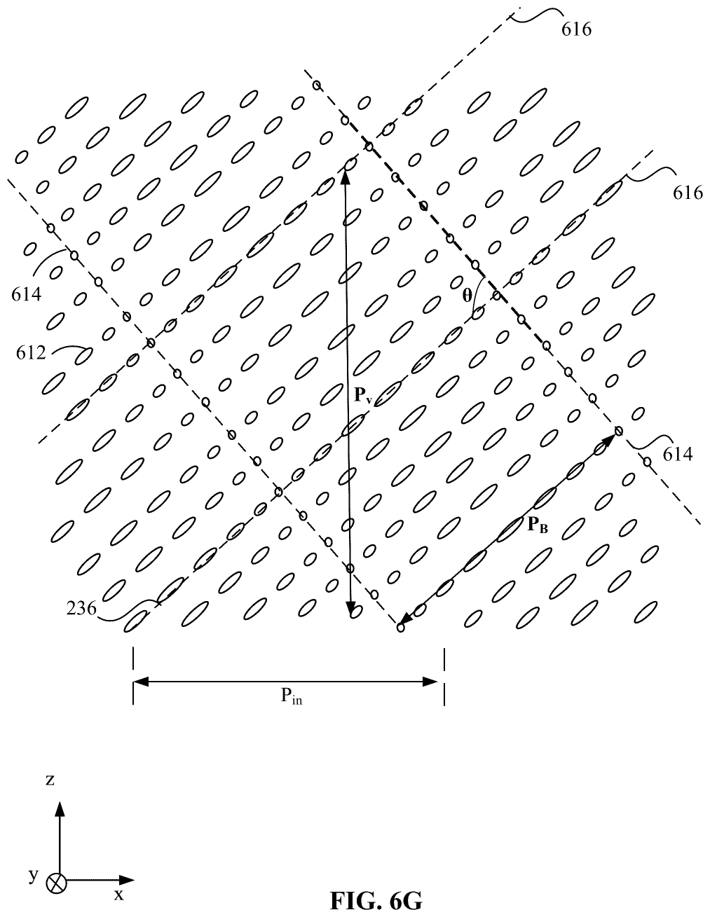

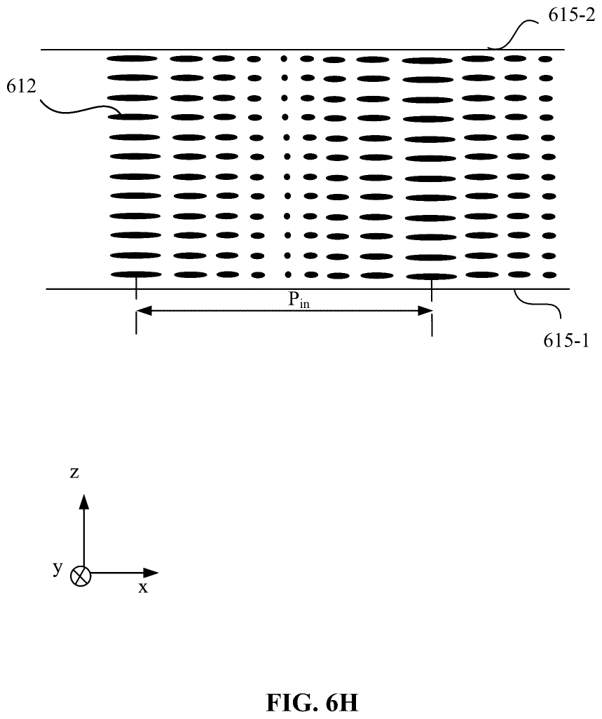

FIG. 6A illustrates a schematic three-dimensional (“3D”) view of an optical film 600 that may be included in an optical component (or optical element) disclosed herein. For example, the optical film 600 may be the second layer 455 included in the sample 450, as shown in FIG. 4A. The optical component may include a layered structure with multiple layers or a single-layer structure with a single layer. A light 602 may be obliquely incident onto the optical film 600. FIGS. 6B-6D schematically illustrate various views of a portion of the optical film 600 shown in FIG. 6A, showing in-plane orientations of optically anisotropic molecules in the optical film 600, according to various embodiments of the present disclosure. FIGS. 6E-6H schematically illustrate various views of a portion of the optical film 600 shown in FIG. 6A, showing out-of-plane orientations of optically anisotropic molecules in the optical film 600, according to various embodiments of the present disclosure.

As shown in FIG. 6A, although the optical film 600 is shown as having a rectangular plate shape for illustrative purposes, the optical film 600 may have any suitable shape, such as a circular shape. In some embodiments, one or both surfaces along the light propagating path of the light 602 may have curved shapes. In some embodiments, the optical film 600 may include a layer of a birefringent medium 615 with intrinsic or induced (e.g., photo-induced) optical anisotropy, such as liquid crystals, liquid crystal polymers, amorphous polymers. The optical film 600 may also be referred to as a birefringent medium layer 600.

In some embodiments, the optical film 600 may be a polymer layer (or film). For example, in some embodiments, the optical film 600 may be a liquid crystal polymer (“LCP”) layer. In some embodiments, the LCP layer may include polymerized (or cross-linked) LCs, polymer-stabilized LCs, photo-reactive LC polymers, or any combination thereof. The LCs may include nematic LCs, twist-bend LCs, chiral nematic LCs, smectic LCs, or any combination thereof. In some embodiments, the optical film 600 may be a polymer layer including a birefringent photo-refractive holographic material other than LCs, such as an amorphous polymer. The optical film 600 may have a first surface 615-1 on one side and a second surface 615-2 on an opposite side. The first surface 615-1 and the second surface 615-2 may be surfaces along the light propagating path of the incident light 602. In some embodiments, the first surface 615-1 may be an interface between the optical film 600 and a substate (e.g., the first layer 453 shown in FIG. 4A) (or an alignment structure) on which the optical film 600 is formed, and the second surface 615-2 may be an interface between the optical film 600 and a protecting film (e.g., a TAC film) or an outside environment (e.g., air).

The optical film 600 (or the birefringent medium 615 in the optical film 600) may include optically anisotropic molecules (e.g., LC molecules) configured with a three-dimensional (“3D”) orientational pattern. In some embodiments, an optic axis of the birefringent medium 615 or optical film 600 may be configured with a spatially varying orientation in at least one in-plane direction. For example, the optic axis of the LC material may periodically or non-periodically vary in at least one in-plane linear direction, in at least one in-plane radial direction, in at least one in-plane circumferential (e.g., azimuthal) direction, or a combination thereof. The LC molecules may be configured with an in-plane orientation pattern, in which the directors of the LC molecules may periodically or non-periodically vary in the at least one in-plane direction. In some embodiments, the optic axis of the LC material may also be configured with a spatially varying orientation in an out-of-plane direction. The directors of the LC molecules may also be configured with spatially varying orientations in an out-of-plane direction. For example, the optic axis of the LC material (or directors of the LC molecules) may twist in a helical fashion in the out-of-plane direction.

FIGS. 6B-6D schematically illustrate x-y sectional views of a portion of the optical film 600 shown in FIG. 6A, showing in-plane orientations of the optically anisotropic molecules 612 in the optical film 600, according to various embodiments of the present disclosure. The in-plane orientations of the optically anisotropic molecules 612 in the optical film 600 shown in FIGS. 6B-6D are for illustrative purposes. In some embodiments, the optically anisotropic molecules 612 in the optical film 600 may have other in-plane orientation patterns. For discussion purposes, rod-shaped LC molecules 612 are used as examples of the optically anisotropic molecules 612 of the optical film 600. The rod-shaped LC molecule 612 may have a longitudinal axis (or an axis in the length direction) and a lateral axis (or an axis in the width direction). The longitudinal axis of the LC molecule 612 may be referred to as a director of the LC molecule 612 or an LC director. An orientation of the LC director may determine a local optic axis orientation or an orientation of the optic axis at a local point of the optical film 600. The term “optic axis” may refer to a direction in a crystal. A light propagating in the optic axis direction may not experience birefringence (or double refraction). An optic axis may be a direction rather than a single line: lights that are parallel to that direction may experience no birefringence. The local optic axis may refer to an optic axis within a predetermined region of a crystal. For illustrative purposes, the LC directors of the LC molecules 612 shown in FIGS. 6B-6D are presumed to be in the surface of the optical film 600 or in a plane parallel with the surface with substantially small tilt angles with respect to the surface.

FIG. 6B schematically illustrates an x-y sectional view of a portion of the optical film 600, showing a periodic in-plane orientation pattern of the orientations of the LC directors (indicated by arrows 688 in FIG. 6B) of the LC molecules 612 located in close proximity to or at a surface (e.g., at least one of the first surface 615-1 or the second surface 615-2) of the optical film 600. The orientations of the LC directors located in close proximity to or at the surface of the optical film 600 may exhibit a periodic rotation in at least one in-plane direction (e.g., an x-axis direction). The periodically varying in-plane orientations of the LC directors form a pattern. The in-plane orientation pattern of the LC directors shown in FIG. 6B may also be referred to as a grating pattern. Accordingly, the optical film 600 may function as a polarization selective grating, e.g., a PVH grating, or a PBP grating, etc.

As shown in FIG. 6B, the LC molecules 612 located in close proximity to or at a surface (e.g., at least one of the first surface 615-1 or the second surface 615-2) of the optical film 600 may be configured with orientations of LC directors continuously changing (e.g., rotating) in a predetermined direction (e.g., an x-axis direction) along the surface (or in a plane parallel with the surface). The continuous rotation of orientations of the LC directors may form a periodic rotation pattern with a uniform (e.g., same) in-plane pitch Pᵢₙ. The predetermined direction may be any suitable direction along the surface (or in a plane parallel with the surface) of the optical film 600. For illustrative purposes, FIG. 6B shows that the predetermined direction is the x-axis direction. The predetermined direction may be referred to as an in-plane direction, the pitch Pᵢₙ along the in-plane direction may be referred to as an in-plane pitch or a horizontal pitch. The pattern with the uniform (or same) in-plane pitch Pᵢₙ may be referred to as a periodic LC director in-plane orientation pattern. The in-plane pitch Pᵢₙ is defined as a distance along the in-plane direction (e.g., the x-axis direction) over which the orientations of the LC directors exhibit a rotation by a predetermined value (e.g., 180°). In other words, in a region substantially close to (including at) the surface of the optical film 600, local optic axis orientations of the optical film 600 may vary periodically in the in-plane direction (e.g., the x-axis direction) with a pattern having the uniform (or same) in-plane pitch Pᵢₙ.

In addition, in regions located in close proximity to or at the surface (e.g., at least one of the first surface 615-1 or the second surface 615-2) of the optical film 600, the orientations of the directors of the LC molecules 612 may exhibit a rotation in a predetermined rotation direction, e.g., a clockwise direction or a counter-clockwise direction. Accordingly, the rotation of the orientations of the directors of the LC molecules 612 in regions located in close proximity to or at the surface of the optical film 600 may exhibit a handedness, e.g., right handedness or left handedness. In the embodiment shown in FIG. 6B, in regions located in close proximity to or at the surface of the optical film 600, the orientations of the directors of the LC molecules 612 may exhibit a rotation in a clockwise direction. Accordingly, the rotation of the orientations of the directors of the LC molecules 612 in regions located in close proximity to or at the surface of the optical film 600 may exhibit a left handedness.

Although not shown, in some embodiments, in regions located in close proximity to or at the surface (e.g., at least one of the first surface 615-1 or the second surface 615-2) of the optical film 600, the orientations of the directors of the LC molecules 612 may exhibit a rotation in a counter-clockwise direction. Accordingly, the rotation of the orientations of the directors of the LC molecules 612 in regions located in close proximity to or at the surface of the optical film 600 may exhibit a right handedness. Although not shown, in some embodiments, in regions located in close proximity to or at the surface of the optical film 600, domains in which the orientations of the directors of the LC molecules 612 exhibit a rotation in a clockwise direction (referred to as domains D_{L}) and domains in which the orientations of the directors of the LC molecules 612 exhibit a rotation in a counter-clockwise direction (referred to as domains D_{R}) may be alternatingly arranged in at least one in-plane direction, e.g., in x-axis and y-axis directions.

FIG. 6C schematically illustrates an x-y sectional view of a portion of the optical film 600, showing a radially varying in-plane orientation pattern of the LC directors of the LC molecules 612 located in close proximity to or at a surface (e.g., at least one of the first surface 615-1 or the second surface 615-2) of the optical film 600 shown in FIG. 6A. FIG. 6D illustrates a section of the in-plane orientation pattern taken along an x-axis in the optical film 600 shown in FIG. 6C, according to an embodiment of the present disclosure. In a region in close proximity to or at a surface (e.g., at least one of the first surface 615-1 or the second surface 615-2) of the optical film 600, the orientations of the optic axis of the optical film 600 may exhibit a continuous rotation in at least two opposite in-plane directions from a center of the optical film 600 to opposite peripheries of the optical film 600 with a varying pitch. In some embodiments, the in-plane orientation pattern of the orientations of the LC directors shown in FIG. 6C may also be referred to as a lens pattern. Accordingly, the optical film 600 with the LC director orientations shown in FIG. 6C may function as a polarization selective lens, e.g., a PBP lens, or a PVH lens, etc.

As shown in FIG. 6C, the orientations of the LC molecules 612 located in close proximity to or at a surface (e.g., at least one of the first surface 615-1 or the second surface 615-2) of the optical film 600 may be configured with an in-plane orientation pattern having a varying pitch in at least two opposite in-plane directions from a lens center 650 to opposite lens peripheries 655. For example, the orientations of the LC directors of LC molecules 612 located in close proximity to or at the surface of the optical film 600 may exhibit a continuous rotation in at least two opposite in-plane directions (e.g., a plurality of opposite radial directions) from the lens center 650 to the opposite lens peripheries 655 with a varying pitch. The orientations of the LC directors from the lens center 650 to the opposite lens peripheries 655 may exhibit a rotation in a same rotation direction (e.g., clockwise, or counter-clockwise). A pitch Λ of the in-plane orientation pattern may be defined as a distance in the in-plane direction (e.g., a radial direction) over which the orientations of the LC directors (or azimuthal angles ϕ of the LC molecules 612) change by a predetermined angle (e.g., 180°) from a predetermined initial state.

As shown in FIG. 6D, according to the LC director field along the x-axis direction, the pitch Λ may be a function of the distance from the lens center 650. The pitch Λ may monotonically decrease from the lens center 650 to the lens peripheries 655 in the at least two opposite in-plane directions (e.g., two opposite radial directions) in the x-y plane, e.g., Λ₀>Λ₁> . . . >Λᵣ. Λ₀ is the pitch at a central region of the lens pattern, which may be the largest. The pitch Λᵣ is the pitch at a periphery region (e.g., periphery 655) of the lens pattern, which may be the smallest. In some embodiments, the azimuthal angle ϕ of the LC molecule 612 may change in proportional to the distance from the lens center 650 to a local point of the optical film 600 at which the LC molecule 612 is located.

The in-plane orientation patterns of the LC directors shown in FIGS. 6B-6D are for illustrative purposes. The optical film 600 may have any suitable in-plane orientation patterns of the LC directors. For illustrative purposes, FIGS. 6C and 6D show an in-plane orientation pattern of the LC directors when the optical film 600 is a PBP or PVH lens functioning as an on-axis spherical lens. In some embodiments, the optical film 600 may be a PBP or PVH lens functioning as an off-axis spherical lens, a cylindrical lens, an aspheric lens, or a freeform lens, etc.

FIGS. 6E-6H schematically illustrate y-z sectional views of a portion of the optical film 600, showing out-of-plane orientations of the LC directors of the LC molecules 612 in the optical film 600, according to various embodiments of the present disclosure. For discussion purposes, FIGS. 6E-6H schematically illustrate out-of-plane (e.g., along z-axis direction) orientations of the LC directors of the LC molecules 612 when the in-plane (e.g., in a plane parallel to the x-y plane) orientation pattern is a periodic in-plane orientation pattern shown in FIG. 6B. As shown in FIG. 6E, within a volume of the optical film 600, the LC molecules 612 may be arranged in a plurality of helical structures 617 with a plurality of helical axes 618 and a helical pitch Pₕ along the helical axes. The azimuthal angles of the LC molecules 612 arranged along a single helical structure 617 may continuously vary around a helical axis 618 in a predetermined rotation direction, e.g., clockwise direction or counter-clockwise direction. In other words, the orientations of the LC directors of the LC molecules 612 arranged along a single helical structure 617 may exhibit a continuous rotation around the helical axis 618 in a predetermined rotation direction. That is, the azimuthal angles associated of the LC directors may exhibit a continuous change around the helical axis in the predetermined rotation direction. Accordingly, the helical structure 617 may exhibit a handedness, e.g., right handedness or left handedness. The helical pitch Pₕ may be defined as a distance along the helical axis 618 over which the orientations of the LC directors exhibit a rotation around the helical axis 618 by 360°, or the azimuthal angles of the LC molecules vary by 360°.

In the embodiment shown in FIG. 6E, the helical axes 618 may be substantially perpendicular to the first surface 615-1 and/or the second surface 615-2 of the optical film 600. In other words, the helical axes 618 of the helical structures 617 may be in a thickness direction (e.g., a z-axis direction) of the optical film 600. That is, the LC molecules 612 may have substantially small tilt angles (including zero degree tilt angles), and the LC directors of the LC molecules 612 may be substantially orthogonal to the helical axis 618. The optical film 600 may have a vertical pitch Pᵥ, which may be defined as a distance along the thickness direction of the optical film 600 over which the orientations of the LC directors of the LC molecules 612 exhibit a rotation around the helical axis 618 by 180° (or the azimuthal angles of the LC directors vary by 180°). In the embodiment shown in FIG. 6E, the vertical pitch Pᵥ may be half of the helical pitch Ph.

As shown in FIG. 6E, the LC molecules 612 from the plurality of helical structures 617 having a first same orientation (e.g., same tilt angle and azimuthal angle) may form a first series of parallel refractive index planes 614 periodically distributed within the volume of the optical film 600. Although not labeled, the LC molecules 612 with a second same orientation (e.g., same tilt angle and azimuthal angle) different from the first same orientation may form a second series of parallel refractive index planes periodically distributed within the volume of the optical film 600. Different series of parallel refractive index planes may be formed by the LC molecules 612 having different orientations. In the same series of parallel and periodically distributed refractive index planes 614, the LC molecules 612 may have the same orientation and the refractive index may be the same. Different series of refractive index planes 614 may correspond to different refractive indices. When the number of the refractive index planes 614 (or the thickness of the birefringent medium layer) increases to a sufficient value, Bragg diffraction may be established according to the principles of volume gratings. Thus, the periodically distributed refractive index planes 614 may also be referred to as Bragg planes 614. In some embodiments, as shown in FIG. 6E, the refractive index planes 614 may be slanted with respect to the first surface 615-1 or the second surface 615-2. In some embodiments, the refractive index planes 614 may be perpendicular to or parallel with the first surface 615-1 or the second surface 615-2. Within the optical film 600, there may exist different series of Bragg planes. A distance (or a period) between adjacent Bragg planes 614 of the same series may be referred to as a Bragg period P_{B}. The different series of Bragg planes formed within the volume of the optical film 600 may produce a varying refractive index profile that is periodically distributed in the volume of the optical film 600. The optical film 600 may diffract an input light satisfying a Bragg condition through Bragg diffraction.

As shown in FIG. 6E, the optical film 600 may also include a plurality of LC molecule director planes (or molecule director planes) 616 arranged in parallel with one another within the volume of the optical film 600. An LC molecule director plane (or an LC director plane) 616 may be a plane formed by or including the LC directors of the LC molecules 612. In the example shown in FIG. 6E, the LC directors in the LC director plane 616 have different orientations, i.e., the orientations of the LC directors vary in the x-axis direction. The Bragg plane 614 may form an angle θ with respect to the LC molecule director plane 616. In the embodiment shown in FIG. 6E, the angle θ may be an acute angle, e.g., 0°<θ<90°. The optical film 600 having the out-of-plane orientations shown in FIG. 6E may function as a transmissive PVH element, e.g., a transmissive PVH grating.

In the embodiment shown in FIG. 6F, the helical axes 618 of helical structures 617 may be tilted with respect to the first surface 615-1 and/or the second surface 615-2 of the optical film 600 (or with respect to the thickness direction of the optical film 600). For example, the helical axes 618 of the helical structures 617 may have an acute angle or obtuse angle with respect to the first surface 615-1 and/or the second surface 615-2 of the optical film 600. In some embodiments, the LC directors of the LC molecule 612 may be substantially orthogonal to the helical axes 618 (i.e., the tilt angle may be substantially zero degree). In some embodiments, the LC directors of the LC molecule 612 may be tilted with respect to the helical axes 618 at an acute angle. The optical film 600 may have a vertical periodicity (or pitch) Pᵥ. In the embodiment shown in FIG. 6F, an angle θ (not shown) between the LC director plane 616 and the Bragg plane 614 may be substantially 0° or 180°. That is, the LC director plane 616 may be substantially parallel with the Bragg plane 614. In the example shown in FIG. 6F, the orientations of the directors in the molecule director plane 616 may be substantially the same. The optical film 600 having the out-of-plane orientations shown in FIG. 6F may function as a reflective PVH element, e.g., a reflective PVH grating.

In the embodiment shown in FIG. 6G, the optical film 600 may also include a plurality of LC director planes 616 arranged in parallel within the volume of the optical film 600. In the embodiment shown in FIG. 6G, an angle θ between the LC director plane 616 and the Bragg plane 614 may be a substantially right angle, e.g., θ=90°. That is, the LC director plane 616 may be substantially orthogonal to the Bragg plane 614. In the example shown in FIG. 6G, the LC directors in the LC director plane 616 may have different orientations. In some embodiments, the optical film 600 having the out-of-plane orientations shown in FIG. 6G may function as a transmissive PVH element, e.g., a transmissive PVH grating.

In the embodiment shown in FIG. 6H, in a volume of the optical film 600, along the thickness direction (e.g., the z-axis direction) of the optical film 600, the directors (or the azimuth angles) of the LC molecules 612 may remain in the same orientation (or same angle value) from the first surface 615-1 to the second surface 615-2 of the optical film 600. In some embodiments, the thickness of the optical film 600 may be configured as d=λ/(2*Δn), where λ is a design wavelength, Δn is the birefringence of the LC material of the optical film 600, and Δn=nₑ−nₒ, where nₑ and nₒ are the extraordinary and ordinary refractive indices of the LC material, respectively. In some embodiments, the optical film 600 having the out-of-plane orientations shown in FIG. 6H may function as a PBP element, e.g., a PBP grating.

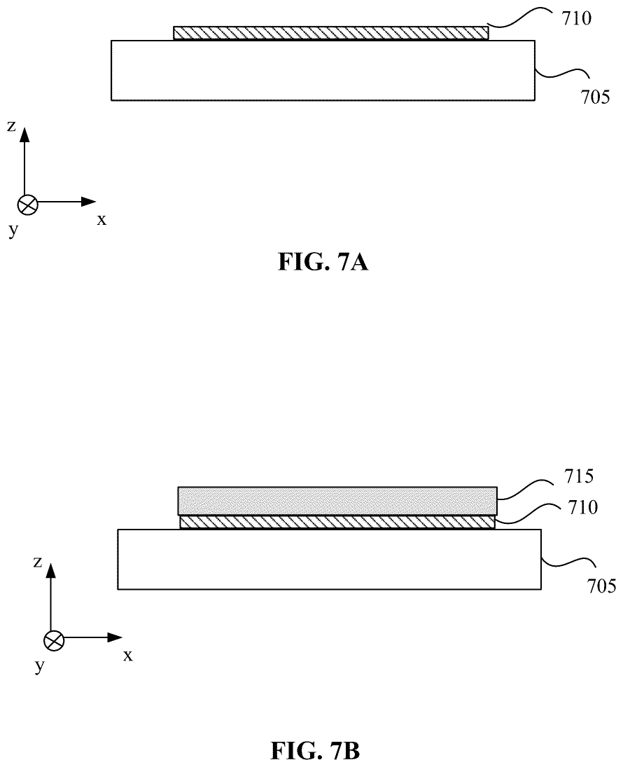

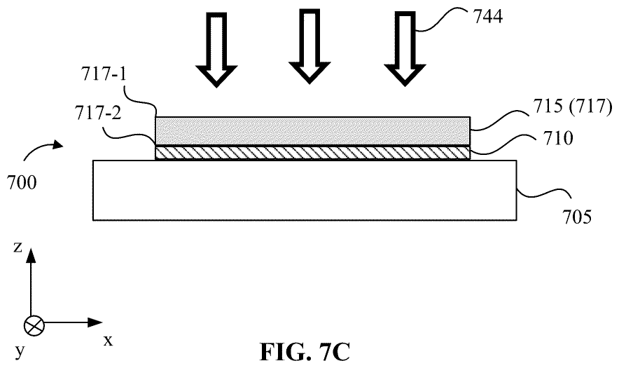

FIGS. 7A-7C schematically illustrate processes for fabricating an optical component 700, according to an embodiment of the present disclosure. The processes shown in FIGS. 7A-7C use a multi-layer optical component (or a layered optical component) as an example. The fabrication process shown in FIGS. 7A-7C may include surface alignment and polymerization. For illustrative purposes, the substrate and different layers, films, or structures formed thereon are shown as having flat surfaces. In some embodiments, the substrate and different layers or films or structures may have curved surfaces. As shown in FIG. 7A, an alignment structure 710 may be formed on a surface (e.g., a top surface) of a substrate 705. The alignment structure 710 may provide an alignment pattern corresponding to a predetermined in-plane orientation pattern, such as the in-plane orientation pattern shown in FIG. 6B or FIG. 6C. The alignment structure 710 may include any suitable alignment structure, such as a photo-alignment material (“PAM”) layer, a mechanically rubbed alignment layer, an alignment layer with anisotropic nanoimprint, an anisotropic relief, or a ferroelectric or ferromagnetic material layer, etc.

In some embodiments, the alignment structure 710 may be a PAM layer, and the alignment pattern provided by the PAM layer may be formed via any suitable approach, such as holographic interference, laser direct writing, ink-jet printing, or various other forms of lithography. The PAM layer may include a polarization sensitive material (e.g., a photo-alignment material) that can have a photo-induced optical anisotropy when exposed to a polarized light irradiation. Molecules (or fragments) and/or photo-products of the polarization sensitive material may be configured to generate an orientational ordering under the polarized light irradiation. For example, the polarization sensitive material may be dissolved in a solvent to form a solution. The solution may be dispensed on the substrate 705 using any suitable solution dispensing process, e.g., spin coating, slot coating, blade coating, spray coating, or jet (ink-jet) coating or printing. The solvent may be removed from the coated solution using a suitable process, e.g., drying, or heating, thereby leaving the polarization sensitive material on the substrate 705.

The polarization sensitive material may be optically patterned via the polarized light irradiation, to form the alignment pattern corresponding to a predetermined in-plane orientation pattern. In some embodiments, the polarization sensitive material may include elongated anisotropic photo-sensitive units (e.g., small molecules or fragments of polymeric molecules). After being subjected to a sufficient exposure of the polarized light irradiation, local alignment directions of the anisotropic photo-sensitive units may be induced in the polarization sensitive material, resulting in an alignment pattern (or in-plane modulation) of an optic axis of the polarization sensitive material.

In some embodiments, an entire layer of the polarization sensitive material may be formed on the substate via a single dispensing process, and the layer of the polarization sensitive material may be subjected to the polarized light irradiation that has a substantially uniform intensity and spatially varying orientations (or polarization directions) of linear polarizations in a predetermined space in which the entire layer of the polarization sensitive material is disposed. In some embodiments, an entire layer of the polarization sensitive material may be formed on the substate via a plurality of dispensing processes. For example, during a first time period, a first predetermined amount of the polarization sensitive material may be dispensed at a first location of the substate 705, and exposed to a first polarized light irradiation. During a second time period, a second predetermined amount of the polarization sensitive material may be dispensed at a second location of the substate 705, and exposed to a second polarized light irradiation. The first polarized light irradiation may have a first uniform intensity, and a first linear polarization direction in a space in which the first predetermined amount of the polarization sensitive material is disposed. The second polarized light irradiation may have a second uniform intensity, and a second linear polarization direction in a space in which the second predetermined amount of the polarization sensitive material is disposed. The first uniform intensity and the second uniform intensity may be substantially the same. The first linear polarization direction and the second linear polarization direction may be substantially the same or different from one another. The process may be repeated until a PAM layer that provides a desirable alignment pattern is obtained.

The substrate 705 may provide support and protection to various layers, films, and/or structures formed thereon. In some embodiments, the substrate 705 may also be transparent in the visible wavelength band (e.g., about 380 nm to about 700 nm). In some embodiments, the substrate 705 may also be at least partially transparent in at least a portion of the infrared (“IR”) band (e.g., about 700 nm to about 1 mm). The substrate 705 may include a suitable material that is at least partially transparent to lights of the above-listed wavelength ranges, such as, a glass, a plastic, a sapphire, or a combination thereof, etc. The substrate 705 may be rigid, semi-rigid, flexible, or semi-flexible. The substrate 705 may include a flat surface or a curved surface, on which the different layers or films may be formed. In some embodiments, the substrate 705 may be a part of another optical element or device (e.g., another opto-electrical element or device). For example, the substrate 705 may be a solid optical lens, a part of a solid optical lens, or a light guide (or waveguide), etc. In some embodiments, the substrate 705 may be a part of a functional device, such as a display screen.

After the alignment structure 710 is formed on the substate 705, as shown in FIG. 7B, a birefringent medium layer 715 may be formed on the alignment structure 710 by dispensing, e.g., coating or depositing, a birefringent medium onto the alignment structure 710. The birefringent medium may have an intrinsic birefringence, and may include optically anisotropic molecules. In some embodiments, the birefringent medium may include one or more polymerizable birefringent materials, such reactive mesogens (“RMs”). RMs may be also referred to as a polymerizable mesogenic or liquid-crystalline compound, or polymerizable LCs. For discussion purposes, the term “liquid crystal molecules” or “LC molecules” may encompass both polymerizable LC molecules (e.g., RM molecules) and non-polymerizable LC molecules. For discussion purposes, in the following descriptions, RMs are used as an example of polymerizable birefringent materials, and RM molecules are used as an example of optically anisotropic molecules included in a polymerizable birefringent material. In some embodiments, polymerizable birefringent materials other than RMs may also be used.

In some embodiments, the birefringent medium may also include other ingredients, such as solvents, initiators (e.g., photo-initiators or thermal initiators), chiral dopants, or surfactants, etc. In some embodiments, the birefringent medium may not have an intrinsic or induced chirality. In some embodiments, the birefringent medium may have an intrinsic or induced chirality. For example, in some embodiments, the birefringent medium may include a host birefringent material and a chiral dopant doped into the host birefringent material at a predetermined concentration. The chirality may be introduced by the chiral dopant doped into the host birefringent material, e.g., chiral RMs doped into achiral RMs. In some embodiments, the birefringent medium may include a birefringent material having an intrinsic molecular chirality, and chiral dopants may not be doped into the birefringent material. The chirality of the birefringent medium may result from the intrinsic molecular chirality of the birefringent material. For example, the birefringent material may include chiral liquid crystal molecules, or molecules having one or more chiral functional groups.

In some embodiments, a birefringent medium may be dissolved in a solvent to form a solution. A suitable amount of the solution may be dispensed (e.g., coated, or sprayed, etc.) on the alignment structure 710 to form the birefringent medium layer 715, as shown in FIG. 7C. In some embodiments, the solution containing the birefringent medium may be coated on the alignment structure 710 using a suitable process, e.g., spin coating, slot coating, blade coating, spray coating, or jet (ink-jet) coating or printing. In some embodiments, the birefringent medium may be heated to remove the remaining solvent. This process may be referred to as a pre-exposure heating. The alignment structure 710 may provide a surface alignment to at least RM molecules that are in close proximity to (including in contact with) the alignment structure 710. For example, the alignment structure 710 may at least align the RM molecules that are in contact with the alignment structure 710 in the predetermined in-plane orientation pattern. Such an alignment procedure may be referred to as a surface-mediated alignment.

In some embodiments, when the alignment structure 710 is the PAM layer, the RM molecules in the birefringent medium may be at least partially aligned along the local alignment directions of the anisotropic photo-sensitive units in the PAM layer to form the predetermined in-plane orientation pattern. Thus, the alignment pattern formed in the PAM layer (or the in-plane orientation pattern of the optic axis of the PAM layer) may be transferred to the birefringent medium layer 715. Such an alignment procedure may be referred to as a surface-mediated photo-alignment. The photo-alignment material for a surface-mediated photo-alignment may also be referred to as a surface photo-alignment material.

In some embodiments, after the optically anisotropic molecules (e.g., RM molecules) in the birefringent medium layer 715 are aligned by the alignment structure 710, the birefringent medium layer 715 may be heat treated (e.g., annealed) in a temperature range corresponding to a nematic phase of the RMs to enhance the alignments (or orientation pattern) of the RMs (not shown in FIG. 7C). This process may be referred to as a post-exposure heat treatment (e.g., annealing). In some embodiments, the heat treatment of the birefringent medium layer 715 may be omitted.

In some embodiments, after the RMs are aligned by the alignment structure 710, the RMs may be polymerized, e.g., thermally polymerized or photo-polymerized, to solidify and stabilize the orientational pattern of the optic axis of the birefringent medium layer 715. In some embodiments, as shown in FIG. 7C, the birefringent medium layer 715 may be irradiated with, e.g., a UV light 744. Under a sufficient UV light irradiation, the RM monomers in the birefringent medium layer 715 may be polymerized or crosslinked to stabilize the orientational pattern of the optic axis of the birefringent medium layer 715. In some embodiments, the polymerization of the RM monomers under the UV light irradiation may be carried out in air, or in an inert atmosphere formed, for example, by nitrogen, argon, carbon-dioxide, or in vacuum. After the RMs are polymerized, the birefringent medium layer 715 may become an LCP layer 717, e.g., a polymerized RM layer 717. Thus, as FIG. 7C shows, the optical component 700 with a layered structure may be obtained.

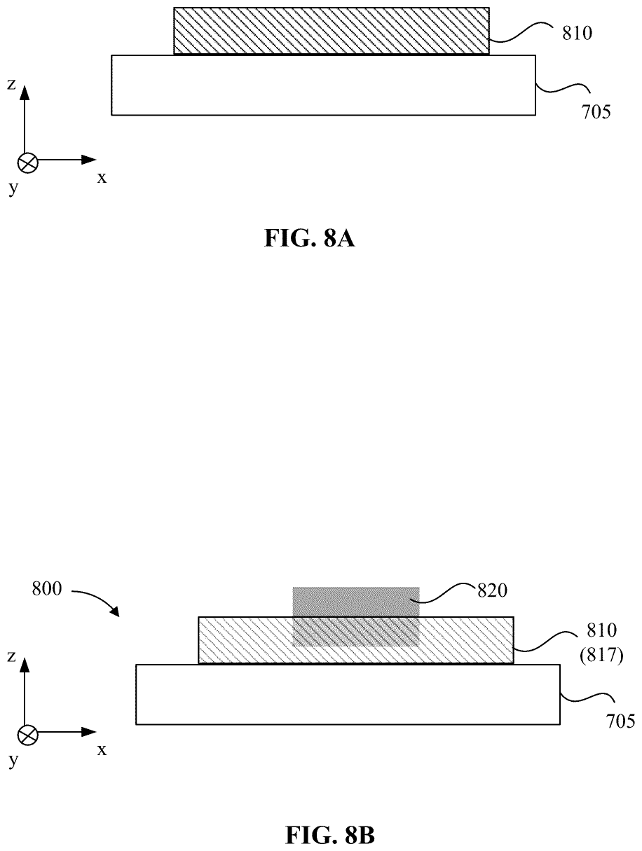

FIGS. 8A and 8B schematically illustrate processes for fabricating an optical component 800 with layered structure, according to an embodiment of the present disclosure. The processes shown in FIGS. 8A and 8B may include dispensing (e.g., coating, depositing, ink-jet printing, etc.) a photo-sensitive polymer on a surface (e.g., a top surface) of the substrate 705 to form a photo-sensitive polymer layer 810. In some embodiments, the photo-sensitive polymer may be mixed with other ingredients, such as a solvent in which the photo-sensitive polymer may be dissolved to form a solution, and photo-sensitizers. The solution may be dispensed on the substrate 705 using a suitable process, e.g., spin coating, slot coating, blade coating, spray coating, or jet (ink-jet) coating or printing. The solvent may be removed from the coated solution using a suitable process, e.g., drying, or heating, leaving the photo-sensitive polymer on the substrate 705.

After the photo-sensitive polymer layer 810 is formed on the substrate 705, as shown in FIG. 8B, the photo-sensitive polymer layer 810 may be exposed to a polarized light irradiation 820. In some embodiments, the polarized light irradiation 820 may have a substantially uniform intensity, and 3D spatially varying orientations (or polarization directions) of linear polarizations within a predetermined space in which the photo-sensitive polymer layer 810 is disposed. That is, the polarized light irradiation 820 may provide a 3D polarization field within the predetermined space in which the photo-sensitive polymer layer 810 is disposed. In some embodiments, the polarized light irradiation 820 may include a polarization interference pattern generated based on two coherent, circularly polarized beams with opposite handednesses. The photo-sensitive polymer layer 810 may be optically patterned when exposed to the polarization interference pattern during the polarization interference exposure process. An orientation pattern of an optic axis of the photo-sensitive polymer layer 810 in an exposed region may be defined during the polarization interference exposure process.

Molecules of the photo-sensitive polymer may include one or more polarization sensitive photo-reactive groups embedded in a main polymer chain or a side polymer chain. During the polarized light irradiation process of the photo-sensitive polymer layer 810, a photo-alignment of the polarization sensitive photo-reactive groups may occur within (or in, inside) a volume of the photo-sensitive polymer layer 810. Thus, a 3D polarization field provided by the polarized light irradiation 820 may be directly recorded within (or in, inside) the volume of the photo-sensitive polymer layer 810. In other words, the photo-sensitive polymer layer 810 may be optically patterned to form a patterned photo-sensitive polymer layer (referred to as 817 in FIG. 8B for discussion purpose). Such an alignment procedure shown in FIG. 8B may be referred to as a bulk-mediated photo-alignment. The photo-sensitive polymer included in the photo-sensitive polymer layer 810 for a bulk-mediated photo-alignment shown in FIG. 8B may also be referred to as a volume recording medium or bulk PAM. The photo-sensitive polymer layer 810 for a bulk-mediated photo-alignment shown in FIG. 8B may be relatively thicker than the PAM layer (e.g., 710) for a surface-mediated photo-alignment shown in FIGS. 7A-7C. Thus, as FIG. 8B shows, the optical component 800 with a layered structure may be obtained.

In some embodiments, the photo-sensitive polymer included in the photo-sensitive polymer layer 810 may include an amorphous polymer, an LC polymer, etc. The molecules of the photo-sensitive polymer may include one or more polarization sensitive photo-reactive groups embedded in a main polymer chain or a side polymer chain. In some embodiments, the polarization sensitive photo-reactive group may include an azobenzene group, a cinnamate group, or a coumarin group, etc. In some embodiments, the photo-sensitive polymer may be an amorphous polymer, which may be initially optically isotropic prior to undergoing the polarized light irradiation 820, and may exhibit an induced (e.g., photo-induced) optical anisotropy after being subjected to the polarized light irradiation 820. In some embodiments, the photo-sensitive polymer may be an LC polymer, in which the birefringence and in-plane orientation pattern may be recorded due to an effect of photo-induced optical anisotropy. In some embodiments, the photo-sensitive polymer may be an LC polymer with a polarization sensitive cinnamate group embedded in a side polymer chain. In some embodiments, when the photo-sensitive polymer layer 810 includes an LC polymer, the patterned photo-sensitive polymer layer 817 may be heat treated (e.g., annealed) in a temperature range corresponding to a liquid crystalline state of the LC polymer to enhance the photo-induced optical anisotropy of the LC polymer (not shown in FIG. 8B).

Referring to FIGS. 7A-8B, in some embodiments, the fabrication process of the optical component 700 or 800 with a layered structure may include additional steps. For example, in some embodiments, the fabrication process may also include forming a protecting film (e.g., a TAC film) on the LCP layer 717 or patterned photo-sensitive polymer layer 817 for protection purposes. In some embodiments, the fabrication process may also include disposing a cover glass on the protecting film. In some embodiments, the optical component 700 fabricated based on the fabrication processes shown in FIGS. 7A-7C and the optical component 800 fabricated based on the fabrication processes shown in FIGS. 8A and 8B may be a liquid crystal polarization hologram (“LCPH”) component or device. For discussion purpose, in the present disclosure, the term “LCPH” may encompass polarization holograms based on LCs and polarization holograms based on birefringent photo-refractive holographic materials other than LCs (e.g., an amorphous polymer). The LCPH component may be a reflective optical component or a transmissive optical component, such as a PBP component, a reflective PVH component, or a transmissive PVH component. In some embodiments, the optical component 700 fabricated based on the fabrication processes shown in FIGS. 7A-7C and the optical component 800 fabricated based on the fabrication processes shown in FIGS. 8A and 8B may be a passive LCPH element.

In some embodiments, the present disclosure provides a system. The system includes a light source configured to emit a probing beam to illuminate an optical element, an image sensor configured to be rotatable around the optical element within a predetermined rotation range, and a controller configured to control the image senor to move to a plurality of angular sub-ranges of the predetermined rotation range to receive a plurality of scattered beams output from the optical element. The image sensor generates a plurality of sets of speckle pattern image data based on the received scattered beams. The sets of speckle pattern image data provide two-dimensional (“2D”) spatial information of speckles. In some embodiments, the image sensor is a camera sensor. In some embodiments, the angular sub-ranges include at least two different angular spans.

In some embodiments, the controller is configured to determining exposure times for the imaging sensor for the plurality of angular sub-ranges of the predetermined rotation range. In some embodiments, the exposure times for the plurality of angular sub-ranges are different. In some embodiments, the controller is configured to pre-set the exposure times in the imaging sensor for the plurality of angular sub-ranges. In some embodiments, the controller is configured to, with the light source turned on, move the imaging sensor around the optical element to the plurality of angular sub-ranges to generate the plurality of sets of speckle pattern image data based on the plurality of scattered beams output from the optical element, using the respective pre-set exposure times at the respective angular sub-ranges, and the plurality of sets of speckle pattern image data include first sets of intensity data relating to the scattered beams output from the optical element. In some embodiments, the controller is configured to, with the light source turned off, move the imaging sensor around the optical element to the plurality of angular sub-ranges to generate a plurality of sets of dark frame image data, using the respective pre-set exposure times at the respective angular sub-ranges, and the plurality of sets of dark frame image data include second sets of intensity data. In some embodiments, the controller is configured to process the plurality of sets of speckle pattern image data and the plurality of sets of dark frame image data to obtain an angular-dependent scattering intensity profile of the optical element. In some embodiments, the controller is configured to: subtract the second sets of intensity data from the corresponding first sets of intensity data to obtain third sets of intensity data for the plurality of scattered beams output from the optical element; normalize the third sets of intensity data by the corresponding exposure times; and process the normalized third sets of intensity data to obtain an angular-dependent scattering intensity profile of the optical element. In some embodiments, the light source includes a plurality of laser light sources associated with a plurality of laser wavelengths.

In some embodiments, the present disclosure provides a method. The method includes determining a plurality of exposure times of an image sensor for a plurality of angular sub-ranges of a predetermined rotation range around an optical element. The method also includes with a light source turned on, moving the imaging sensor around the optical element to the plurality of angular sub-ranges to generate a plurality of sets of speckle pattern image data based on a plurality of scattered beams output from the optical element, using the respective pre-set exposure times at the respective angular sub-ranges. The method also includes with the light source turned off, moving the imaging sensor around the optical element to the plurality of angular sub-ranges to generate a plurality of sets of dark frame image data, using the respective pre-set exposure times at the respective angular sub-ranges. The method also includes processing the plurality of sets of speckle pattern image data and the plurality of sets of dark frame image data to obtain an angular-dependent scattering intensity profile of the optical element.

In some embodiments, the method further includes pre-setting the determined exposure times in the imaging sensor for the plurality of angular sub-ranges. In some embodiments, the image sensor is a camera sensor. In some embodiments, the angular sub-ranges include at least two different angular spans. In some embodiments, the exposure times for the plurality of angular sub-ranges are different. In some embodiments, the plurality of sets of speckle pattern image data include first sets of intensity data relating to the scattered beams output from the optical element, and the plurality of sets of dark frame image data include second sets of intensity data. In some embodiments, processing the plurality of sets of speckle pattern image data and the plurality of sets of dark frame image data to obtain an angular-dependent scattering intensity profile of the optical element further comprises: subtracting the second sets of intensity data from the corresponding first sets of intensity data to obtain third sets of intensity data for the plurality of scattered beams output from the optical element. In some embodiments, the processing the plurality of sets of speckle pattern image data and the plurality of sets of dark frame image data to obtain an angular-dependent scattering intensity profile of the optical element further comprises: normalizing the third sets of intensity data by the corresponding exposure times. In some embodiments, processing the plurality of sets of speckle pattern image data and the plurality of sets of dark frame image data to obtain an angular-dependent scattering intensity profile of the optical element further comprises: processing the normalized third sets of intensity data to obtain the angular-dependent scattering intensity profile of the optical element.

Any of the steps, operations, or processes described herein may be performed or implemented with one or more hardware and/or software modules, alone or in combination with other devices. In one embodiment, a software module is implemented with a computer program product including a computer-readable medium containing computer program code, which can be executed by a computer processor for performing any or all of the steps, operations, or processes described. In some embodiments, a hardware module may include hardware components such as a device, a system, an optical element, a controller, an electrical circuit, a logic gate, etc.

Further, when an embodiment illustrated in a drawing shows a single element, it is understood that the embodiment or an embodiment not shown in the figures but within the scope of the present disclosure may include a plurality of such elements. Likewise, when an embodiment illustrated in a drawing shows a plurality of such elements, it is understood that the embodiment or an embodiment not shown in the figures but within the scope of the present disclosure may include only one such element. The number of elements illustrated in the drawing is for illustration purposes only, and should not be construed as limiting the scope of the embodiment. Moreover, unless otherwise noted, the embodiments shown in the drawings are not mutually exclusive, and they may be combined in any suitable manner. For example, elements shown in one figure/embodiment but not shown in another figure/embodiment may nevertheless be included in the other figure/embodiment. In any optical device disclosed herein including one or more optical layers, films, plates, or elements, the numbers of the layers, films, plates, or elements shown in the figures are for illustrative purposes only. In other embodiments not shown in the figures, which are still within the scope of the present disclosure, the same or different layers, films, plates, or elements shown in the same or different figures/embodiments may be combined or repeated in various manners to form a stack.

Various embodiments have been described to illustrate the exemplary implementations. Based on the disclosed embodiments, a person having ordinary skills in the art may make various other changes, modifications, rearrangements, and substitutions without departing from the scope of the present disclosure. Thus, while the present disclosure has been described in detail with reference to the above embodiments, the present disclosure is not limited to the above described embodiments. The present disclosure may be embodied in other equivalent forms without departing from the scope of the present disclosure. The scope of the present disclosure is defined in the appended claims.

What is claimed is:

1. A system, comprising:
a light source configured to emit a probing beam to illuminate an optical element;
an image sensor configured to be rotatable around the optical element within a predetermined rotation range; and
a controller configured to control the image senor to move to a plurality of angular sub-ranges of the predetermined rotation range to receive a plurality of scattered beams output from the optical element,
wherein the image sensor is configured to generate a plurality of sets of speckle pattern image data based on the received scattered beams, and
wherein the sets of speckle pattern image data provide two-dimensional (“2D”) spatial information of speckles.

2. The system of claim 1, wherein the image sensor is a camera sensor.

3. The system of claim 1, wherein the angular sub-ranges include at least two different angular spans.

4. The system of claim 1, wherein the controller is configured to determining exposure times for the imaging sensor for the plurality of angular sub-ranges of the predetermined rotation range.

5. The system of claim 4, wherein the exposure times for the plurality of angular sub-ranges are different.

6. The system of claim 4, wherein the controller is configured to pre-set the exposure times in the imaging sensor for the plurality of angular sub-ranges.

7. The system of claim 6, wherein
the controller is configured to, with the light source turned on, move the imaging sensor around the optical element to the plurality of angular sub-ranges to generate the plurality of sets of speckle pattern image data based on the plurality of scattered beams output from the optical element, using the respective pre-set exposure times at the respective angular sub-ranges, and
the plurality of sets of speckle pattern image data include first sets of intensity data relating to the scattered beams output from the optical element.

8. The system of claim 7, wherein
the controller is configured to, with the light source turned off, move the imaging sensor around the optical element to the plurality of angular sub-ranges to generate a plurality of sets of dark frame image data, using the respective pre-set exposure times at the respective angular sub-ranges, and
the plurality of sets of dark frame image data include second sets of intensity data.

9. The system of claim 8, wherein the controller is configured to process the plurality of sets of speckle pattern image data and the plurality of sets of dark frame image data to obtain an angular-dependent scattering intensity profile of the optical element.

10. The system of claim 9, wherein the controller is configured to:
subtract the second sets of intensity data from the corresponding first sets of intensity data to obtain third sets of intensity data for the plurality of scattered beams output from the optical element;
normalize the third sets of intensity data by the corresponding exposure times; and
process the normalized third sets of intensity data to obtain an angular-dependent scattering intensity profile of the optical element.

11. The system of claim 1, wherein the light source includes a plurality of laser light sources associated with a plurality of laser wavelengths.

12. A method, comprising:
determining a plurality of exposure times of an image sensor for a plurality of angular sub-ranges of a predetermined rotation range around an optical element;
with a light source turned on, moving the imaging sensor around the optical element to the plurality of angular sub-ranges to generate a plurality of sets of speckle pattern image data based on a plurality of scattered beams output from the optical element, using the respective pre-set exposure times at the respective angular sub-ranges;
with the light source turned off, moving the imaging sensor around the optical element to the plurality of angular sub-ranges to generate a plurality of sets of dark frame image data, using the respective pre-set exposure times at the respective angular sub-ranges; and
processing the plurality of sets of speckle pattern image data and the plurality of sets of dark frame image data to obtain an angular-dependent scattering intensity profile of the optical element.

13. The method of claim 12, further comprising pre-setting the determined exposure times in the imaging sensor for the plurality of angular sub-ranges.

14. The method of claim 12, wherein the image sensor is a camera sensor.

15. The method of claim 12, wherein the angular sub-ranges include at least two different angular spans.

16. The method of claim 12, wherein the exposure times for the plurality of angular sub-ranges are different.

17. The method of claim 12, wherein the plurality of sets of speckle pattern image data include first sets of intensity data relating to the scattered beams output from the optical element, and the plurality of sets of dark frame image data include second sets of intensity data.

18. The method of claim 17, wherein processing the plurality of sets of speckle pattern image data and the plurality of sets of dark frame image data to obtain an angular-dependent scattering intensity profile of the optical element further comprises:
subtracting the second sets of intensity data from the corresponding first sets of intensity data to obtain third sets of intensity data for the plurality of scattered beams output from the optical element.

19. The method of claim 18, wherein processing the plurality of sets of speckle pattern image data and the plurality of sets of dark frame image data to obtain an angular-dependent scattering intensity profile of the optical element further comprises:
normalizing the third sets of intensity data by the corresponding exposure times.

20. The method of claim 19, wherein processing the plurality of sets of speckle pattern image data and the plurality of sets of dark frame image data to obtain an angular-dependent scattering intensity profile of the optical element further comprises:
processing the normalized third sets of intensity data to obtain the angular-dependent scattering intensity profile of the optical element.
